(19) United States
(12) Patent Application Publication
(10) Pub. No.: US 2025/0206369 A1
(43) Pub. Date: Jun. 26, 2025

(54) METHODS AND APPARATUS TO CONTROL STEERING ASSISTANCE

(71) Applicant: Ford Global Technologies, LLC, Dearborn, MI (US)

(72) Inventors: Maxwell Alestra, Livonia, MI (US); Troy Fischer, Novi, MI (US); Ghanshyam M. Patel, Canton, MI (US)

(21) Appl. No.: 18/391,647

(22) Filed: Dec. 20, 2023

(51) Int. Cl. B62D 6/00; B62D 5/00

(52) U.S. Cl. CPC B62D 6/00; B62D 5/006

(57) ABSTRACT

Methods and apparatus to control steering assistance are disclosed. An example vehicle includes a steering wheel, a steerable wheel operatively coupled to the steering wheel, and programmable circuitry to identify a first angular displacement of the steering wheel, cause the steerable wheel to have a second angular displacement corresponding to the first angular displacement of the steering wheel at a first time, and cause the steerable wheel to have a third angular displacement corresponding to the first angular displacement of the steering wheel at a second time different from the first time, the third angular displacement different from the second angular displacement.

### FIELD OF THE DISCLOSURE

This disclosure relates generally to steerable vehicles and, more particularly, to methods and apparatus to control steering assistance.

### BACKGROUND

Power steering enables drivers to more easily turn a steering wheel and, in turn, road wheels when maneuvering a vehicle. For example, hydraulic and/or electric actuators add controlled energy to the steering actuator when the driver turns the steering wheel to reduce the physical effort necessary to turn the road wheels.

### SUMMARY

Example methods and apparatus to control steering assistance are disclosed herein. An example vehicle includes a steering wheel, a steerable wheel operatively coupled to the steering wheel, and programmable circuitry to identify a first angular displacement of the steering wheel, cause the steerable wheel to have a second angular displacement corresponding to the first angular displacement of the steering wheel at a first time, and cause the steerable wheel to have a third angular displacement corresponding to the first angular displacement of the steering wheel at a second time different from the first time, the third angular displacement different from the second angular displacement.

An example apparatus includes interface circuitry, machine readable instructions, and programmable circuitry to at least one of instantiate or execute the machine readable instructions to cause an adjustment to a relationship between a steering wheel angle change and an orientational change of steerable wheels based on a maneuver to be performed by a vehicle.

An example method includes identifying a first angular displacement of a steering wheel of a vehicle, causing a steerable wheel to have a second angular displacement corresponding to the first angular displacement of the steering wheel at a first time, and causing the steerable wheel to have a third angular displacement corresponding to the first angular displacement of the steering wheel at a second time different from the first time, the third angular displacement different from the second angular displacement.

### BRIEF DESCRIPTION OF THE DRAWINGS

FIG. 1 is a block diagram of an example vehicle including example steering control circuitry.

FIG. 2 is a schematic representation of an example actuator of the vehicle of FIG. 1 in association with the steering control circuitry of FIG. 1.

FIG. 3 is a schematic representation of another example actuator of the vehicle of FIG. 1 in association with the steering control circuitry of FIG. 1.

FIG. 4 is a block diagram of the example steering control circuitry of FIGS. 1, 2, and/or 3.

FIG. 5 is a schematic diagram of an example environment in which the example vehicle of FIG. 1 operates.

FIG. 6 is a first flowchart representative of example machine readable instructions and/or example operations that may be executed, instantiated, and/or performed by example programmable circuitry to implement the steering control circuitry of FIG. 4.

FIG. 7 is a second flowchart representative of example machine readable instructions and/or example operations that may be executed, instantiated, and/or performed by example programmable circuitry to implement the steering control circuitry of FIG. 4.

FIG. 8 is a third flowchart representative of example machine readable instructions and/or example operations that may be executed, instantiated, and/or performed by example programmable circuitry to implement the steering control circuitry of FIG. 4.

FIG. 9 is a block diagram of an example processing platform including programmable circuitry structured to execute, instantiate, and/or perform the example machine readable instructions and/or perform the example operations of FIGS. 6, 7, and 8 to implement the steering control circuitry of FIG. 4.

In general, the same reference numbers will be used throughout the drawing(s) and accompanying written description to refer to the same or like parts. The figures are not necessarily to scale.

### DETAILED DESCRIPTION

Traditional vehicular steering wheels have long included a circular shape. The persistent circularly shaped steering wheel can largely be attributed to a substantial angular adjustment (e.g., turning the steering wheel more than 90 degrees)) (° that a driver needs to input to the steering wheel to make certain maneuvers (e.g., a right or left 90° turn, a U-turn, etc.) as a uniformity in the circular shape allows the driver to encounter the same structure regardless of the degree to which the steering wheel is rotated. For instance, a driver may need to rotate a steering wheel over 360° to make a turn. Furthermore, certain steering techniques (e.g., hand-over-hand steering) have been developed to help drivers input such substantial angular adjustments. These techniques have become and remain prevalent as a result of the uniformity in the circular shape of the steering wheel.

However, the substantial adjustment to the angular orientation of the steering wheel that some vehicular maneuvers necessitate have been an obstacle to deviation in the shape of the steering at least partly because known steering techniques do not translate to non-circular steering wheels. As such, vehicular manufacturers have largely maintained the standard circular shape in their steering wheels. Further, while some have explored non-circular options (e.g., steering yokes), such options have been largely left unadopted as prevalent steering techniques to implement the substantial rotation needed do not translate to the non-circular shape. For instance, with a non-circular steering wheel, the driver must change the way they grab or grip the steering wheel based on the angle to which the steering wheel is rotated, which can be uncomfortable to drivers.

Examples disclosed herein control (e.g., adjust, increase, etc.) steering assistance to enable vehicular maneuvers to be made with a reduced rotation of the steering wheel. As used herein, an adjustment to steering assistance refers to an adjustment of a relationship between (i) a first angular displacement and/or a first rotation of a steering wheel and (ii) a second angular displacement and/or a second rotation of steerable wheels that results from the first angular displacement and/or the first rotation. For example, the examples disclosed herein can adjust the steering assistance to enable a sharp turn (e.g., a 90° or greater turn) to be made with approximately a 90° degree rotation of the steering wheel. As such, examples disclosed herein reduce driver discomfort in using a non-circular steering wheel and, thus, enable such non-circular steering wheels to become more widely adopted. More generally, examples disclosed herein enable vehicles to be maneuvered with substantially less input (e.g., less torque, less angular rotation) at the steering wheel.

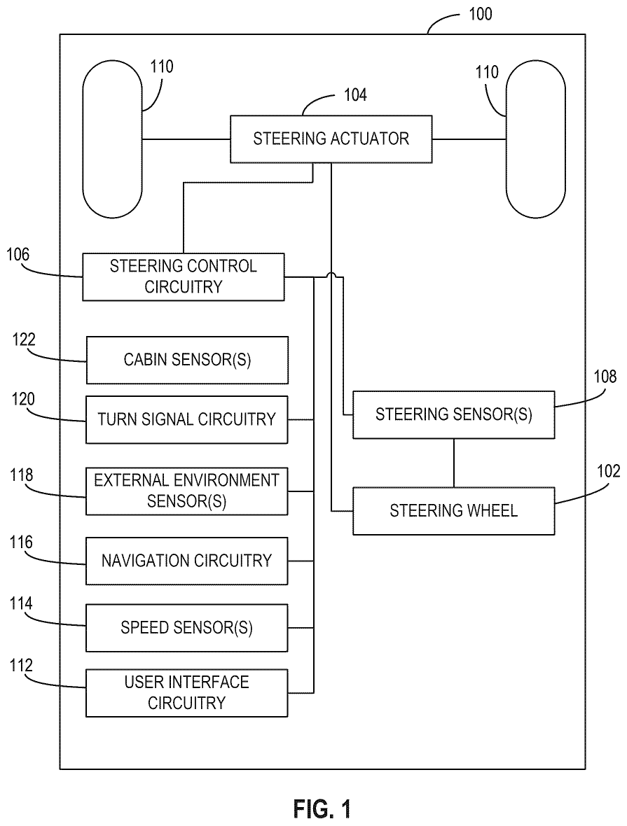

FIG. 1 is a block diagram of an example vehicle 100. In the illustrated example of FIG. 1, the vehicle 100 includes a steering wheel 102, a steering actuator 104, steering control circuitry 106, one or more steering sensor(s) 108, and steerable wheels 110 operatively coupled to the steering actuator 104. The steerable wheels 110 can correspond to front steerable wheels 110 and/or rear steerable wheels 110. The steering sensor(s) 108 can be implemented by, for example, a rotary position sensor, a torque sensor, an optical sensor, a Hall effect sensor, etc., which detect a rotational position of the steering wheel 102 and/or a steering column coupled to the steering wheel 102. In some examples, the vehicle 100 is a steer-by-wire vehicle in which the steering wheel 102 is not directly mechanically connected to the steerable wheels 110. In such examples, the steering sensor(s) 108 measure a steering wheel angle of the steering wheel 102, and the steering control circuitry 106 causes the steering actuator 104 to turn the steerable wheels 110 based on the measured steering wheel angle. In some examples, the steering wheel 102 is directly mechanically connected to the steering actuator 104 and, in turn, the steerable wheels 110.

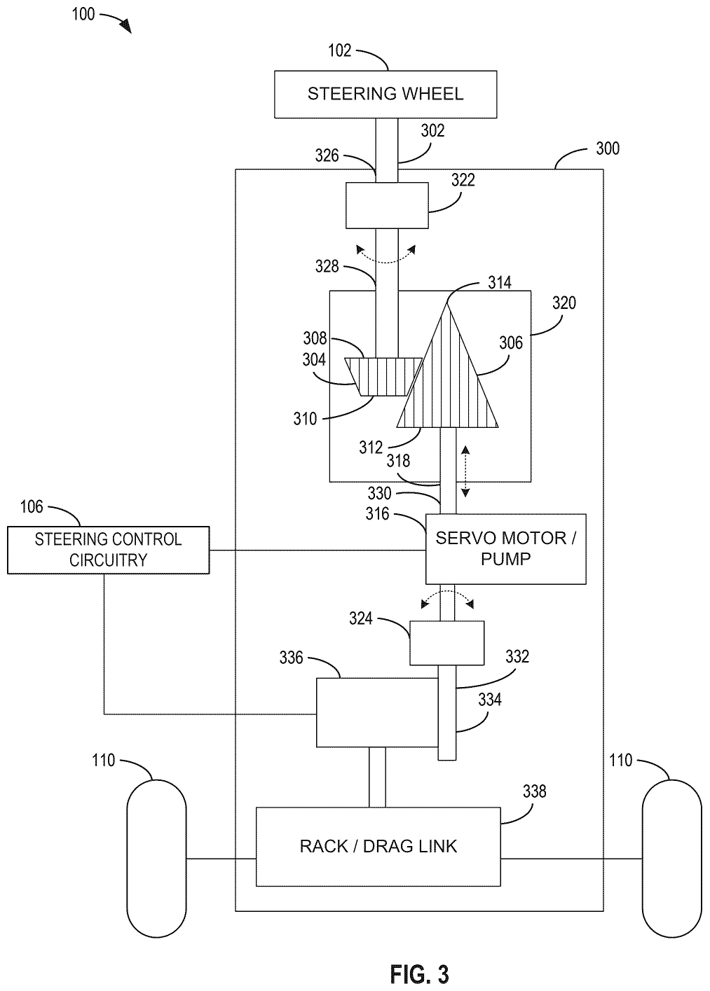

In the example of FIG. 1, the steering actuator 104 includes a rack and pinion, a recirculating ball, and/or another steering gear system to move a rack that pivots the steerable wheels 110. Additionally, the steering actuator 104 includes at least one servo motor and/or pump (e.g., a hydraulic pump, a pneumatic pump). For example, the servo motor and/or the pump can drive the steering gear system based on the measured steering wheel angle. Additionally or alternatively, the servo motor and/or the pump can alter a gear ratio in the steering actuator 104, as discussed further in association with FIG. 3.

In the illustrated example of FIG. 1, the steering control circuitry 106 is communicatively coupled to the servo motor and/or the pump. For example, the steering control circuitry 106 can control a drive signal transmitted to the steering actuator 104 based on the measured steering wheel angle to cause the steerable wheels 110 to move to a position that corresponds with the measured steering wheel angle and, thus, a direction in which a user (e.g., an operator, a driver) wants the vehicle to travel. That is, the drive signal can cause the servo motor and/or the pump of the steering actuator 104 to move the steerable wheels 110 based on the measured steering wheel angle.

In the illustrated example of FIG. 1, the steering control circuitry 106 adjusts a relationship between a first change in angular orientation of the steerable wheels 110 and a second change in angular orientation of the steering wheel 102 (referred to herein as a “steering relationship”). For example, the steering relationship can include a relationship between (i) an input that the steering control circuitry 106 receives from the steering sensor(s) 108 and (ii) an output that the steering control circuitry 106 transmits to the steering actuator 104. Accordingly, the steering relationship can also be referred to as a “steering ratio” or a “turning ratio” of (i) a change in angular displacement of the steerable wheels 110 (e.g., an orientational change of the steerable wheels 110) to (ii) an angular rotation of the steering wheel 102 (e.g., a steering wheel angle change). Thus, when the steering control circuitry 106 increases the steering ratio, the change in angular displacement of the steerable wheels 110 per degree of angular rotation of the steering wheel 102 increases.

In some examples, the steering control circuitry 106 adjusts the steering relationship based on a direction in which the vehicle 100 is projected to travel (e.g., a direction in which the operator is advised to travel) and/or one or more directions in which the vehicle 100 will potentially travel. For example, when the vehicle 100 is projected to make a U-turn within a relatively small radius, the steering control circuitry 106 can adjust the steering relationship to enable a 90° rotation of the steering wheel 102 to cause an adjustment to the angular orientation of the steerable wheels 110 that provides a heading that enables the U-turn to be performed within the relatively small radius. As a result, the adjusted steering relationship enables the driver to maneuver the vehicle 100 while avoiding or otherwise reducing a substantial angular rotation (e.g., more than 90° from a straightaway heading) at the steering wheel 102. As such, the steering wheel 102 can include a non-circular shape that can still be comfortably and securely gripped and manipulated by the user to control the heading of the vehicle 100.

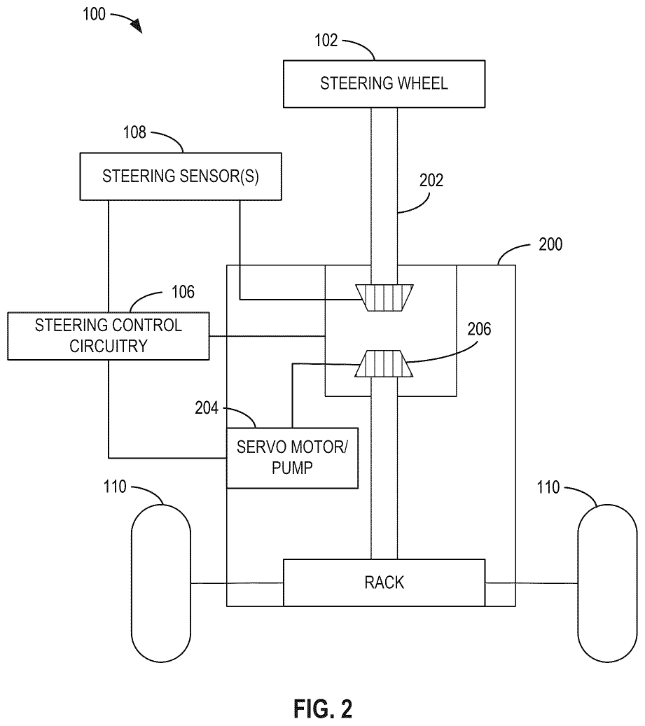

In some examples, to adjust the steering relationship, the steering control circuitry 106 adjusts a relationship between the drive signal transmitted to the steering actuator 104 and an angular rotation of the steering wheel 102 (e.g., a change in angular orientation of the steering wheel 102), as discussed further in association with FIG. 2. In some examples, to adjust the steering relationship, the steering control circuitry 106 adjusts a gear ratio within the steering actuator 104, as discussed further in association with FIG. 3.

In the illustrated example of FIG. 1, the vehicle 100 includes user interface circuitry 112 to enable an operator (e.g., the driver) to control utilization of a variable steering assistance mode by the vehicle 100. As used herein, a “variable steering assistance mode” enables the steering control circuitry 106 to adjust the steering relationship based on a maneuver to be performed by the vehicle 100. For example, the user interface circuitry 112 can include a touchscreen that enables the operator to activate the variable steering assistance mode. Additionally or alternatively, the user interface circuitry 112 can include another input device to enable the operator to provide an on/off indication and output device to enable the vehicle 100 to provide confirmation of the on/off indication. For example, the user interface circuitry 112 can include a button that the operator can press, a light that illuminates when the variable steering assistance mode is active, and/or a microphone and speaker for voice control and/or confirmation. When the user interface circuitry 112 receives an input indicative of a desired activation of the variable steering assistance mode, the user interface circuitry 112 can transmit a signal to the steering control circuitry 106 to enable adjustments to the steering relationship.

In some examples, the vehicle 100 includes a speed sensor 114 in communication with the steering control circuitry 106. The speed sensor 114 detects a speed of the vehicle 100. In some examples, the steering control circuitry 106 prevents utilization of the variable steering assistance mode and/or limits steering relationships provided in the variable steering assistance mode based on the speed of the vehicle 100. For example, the steering control circuitry 106 can prevent an adjustment to the steering relationship when the speed sensor 114 measures a first speed that does not satisfy (e.g., is greater than, is greater than or equal to) a first speed threshold. That is, the steering control circuitry 106 can cause the steering relationship to return to a preset state (e.g., a factory setting, a no relative gain state). More particularly, when the vehicle 100 is traveling at the first speed, which does not satisfy the first speed threshold, the steering control circuitry 106 will prevent (e.g., not enable) a 90° rotation of the steering wheel 102 to cause the steerable wheels 110 to move to an angular orientation that would cause a sharp turn (e.g., a change in a heading of the vehicle 100 by less than) 90° to be performed within a relatively small radius. In some examples, the steering relationship associated with the vehicle 100 in the preset state is based on a design of the steering actuator 104.

In another example, the speed sensor 114 measures a second speed that is less than the first speed and that satisfies (e.g., is less than, is less than or equal to) the first speed threshold and does not satisfy (e.g., is greater than or equal to, is greater than) a second speed threshold. In such examples, the steering control circuitry 106 enables an adjustment to the steering ratio that satisfies (e.g., is less than, is less than or equal to) a ratio adjustment threshold. More particularly, the ratio adjustment threshold can correspond to an allowable (e.g., maximum) change in angular displacement of the steerable wheels 110 per angle of rotation of the steering wheel 102 when the vehicle 100 is traveling at a speed that does not satisfy the second speed threshold. For example, when the vehicle 100 is traveling at the second speed, which satisfies the first speed threshold and does not satisfy the second speed threshold, the steering control circuitry 106 will enable a 90° rotation of the steering wheel 102 to cause the steerable wheels 110 to move to an angular orientation that would cause a sharp turn (e.g., a change in a heading of the vehicle 100 by less than) 90° to be performed within a relatively small radius but will not enable the 90° rotation of the steering wheel 102 to cause a U-turn (e.g., a 180° change in heading) within the relatively small radius.

In another example, when the speed sensor 114 measures a third speed that is less than the second speed and satisfies (e.g., is less than, is less than or equal to) the second speed threshold, the steering control circuitry 106 enables a 90° rotation of the steering wheel 102 to cause the steerable wheels 110 to move to an angular orientation that would cause the U-turn within the relatively small radius. Accordingly, the steering control circuitry 106 prevents the steering relationship from being overly sensitive at certain speeds while enabling maneuvers to be performed with a reduced rotation of the steering wheel 102 (e.g., less than or equal to) 90° when a speed threshold(s) permits. In some examples, the speed thresholds and the steering adjustment relationships associated therewith are based on a size and/or a shape of the vehicle 100 and, thus, can differ from vehicle to vehicle.

In some examples, the vehicle 100 includes navigation circuitry 116 to determine the direction in which the vehicle 100 is projected to travel. For example, the navigation circuitry 116 can communicate with a global positioning system (GPS) to determine directions for the vehicle 100 to follow to travel to a destination location. In some examples, the navigation circuitry 116 is implemented by a user device, such as a cellular phone, that connects with the vehicle 100 (e.g., via Bluetooth®, via Universal Serial Bus (USB), etc.) to facilitate communications between the navigation circuitry 116 and the steering control circuitry 106. In the illustrated example of FIG. 1, the navigation circuitry 116 is in communication with the steering control circuitry 106. In some examples, when the variable steering assistance mode is active, the steering control circuitry 106 determines a projected angular displacement and/or a range of projected angular displacements in which the steerable wheels 110 are to be positioned to enable the vehicle 100 to travel in accordance with the determined directions. In such examples, the steering control circuitry 106 adjusts the steering relationship to enable a reduced angular rotation of the steering wheel 102 to implement an angular displacement at the steerable wheels that corresponds with the projected angular displacement and/or the range of angular displacements.

In some examples, the vehicle 100 includes one or more external environment sensor(s) 118 to enable the steering control circuitry 106 to determine the direction(s) in which the vehicle 100 will potentially travel and/or detect potential obstructions within a range of the vehicle 100. For example, the external environment sensor(s) 118 can include optical sensors (e.g., a camera(s), a radar system, light detection and ranging (LiDAR) scanners) that provide information about the surroundings of the vehicle 100.

In some examples, the steering control circuitry 106 identifies a potential maneuver to be performed by the vehicle based on optics detected by the external environment sensor(s) 118. For example, the external environment sensor(s) 118 can detect a geometry of the roadway and/or obstructions (e.g., obstacles, pedestrians, other vehicles, etc.) around the vehicle 100. In some examples, the steering control circuitry 106 adjusts the steering relationship based on the detected geometry of the roadway and/or the detected obstructions. Additionally, the steering control circuitry 106 can identify a traffic lane that the vehicle 100 is in and/or that the vehicle 100 is approaching an intersection based on data from the external environment sensor(s) 118. As such, the steering control circuitry 106 can adjust the steering relationship based on where the vehicle 100 is positioned on a road.

In the illustrated example of FIG. 1, the vehicle 100 includes turn signal circuitry 120 communicatively coupled to the steering control circuitry 106. As a result, the steering control circuitry 106 can identify activation of a right turn signal or a left turn signal based on information from (e.g., a signal transmitted by) the turn signal circuitry 120. In some examples, the steering control circuitry 106 increases the steering ratio when the steering control circuitry 106 identifies, based on data from the external environment sensor(s) 118 and the turn signal circuitry 120, that the vehicle 100 is in a right turn lane with a right turn signal activated.

In the illustrated example of FIG. 1, the vehicle 100 includes one or more cabin sensor(s) 122 to monitor a behavior of the driver of the vehicle 100. For example, the cabin sensor(s) 122 can include an optical sensor(s), an infrared sensor(s), a motion sensor, etc. In some examples, the steering control circuitry 106 determines whether the driver is incapacitated based on measurements by the cabin sensor(s) 122. In such examples, when the driver is incapacitated, the steering control circuitry 106 can control the position of the steerable wheels 110 independent of the position of the steering wheel 102.

FIG. 2 illustrates a first example steering actuator 200 that can be utilized to implement the steering actuator 104 of FIG. 1. More particularly, the steering actuator 200 of FIG. 2 is representative of an example implementation of the steering actuator 104 of FIG. 1 when the vehicle 100 is a steer-by-wire vehicle. In the illustrated example of FIG. 2, the steering wheel 102 is operatively coupled to a steering column 202. As such, the steering column 202 rotates with the steering wheel 102. The steering sensor(s) 108 measure a rotational position of the steering column 202 and, thus, the steering wheel 102.

As discussed above, the steering control circuitry 106 determines a steering relationship for the vehicle 100 to utilize. As a result, the steering control circuitry 106 transmits a drive signal to a servo motor or pump 204 of the steering actuator 200 based on the determined steering relationship and the measured rotational position of the steering column 202. Specifically, the steering control circuitry 106 controls a parameter (e.g., a voltage, a current, a power, etc.) of the drive signal to implement the determined steering relationship in association with the measured rotational position of the steering column 202. As a result, the drive signal causes the servo motor or pump 204 to drive a rotation of a steering gear 206 operatively coupled to a rack 208 that turns the steerable wheels 110. For example, the determined steering relationship can result in a drive signal from the steering control circuitry 106 that causes the servo motor or pump 204 to rotate the steering gear 206 three times per 45° rotation of the steering shaft 202. As such, the steering control circuitry 106 enables the steerable wheels 110 to turn a substantial degree with a 45° rotation of the steering wheel 102.

FIG. 3 illustrates another example steering actuator 300 that can be utilized to implement the steering actuator 104 of FIG. 1. More particularly, the steering actuator 300 of FIG. 3 is representative of an example implementation of the steering actuator 104 of FIG. 1 when the vehicle 100 includes a mechanical connection between the steering wheel 102 and the steerable wheels 110. In the illustrated example of FIG. 3, the steering wheel 102 is coupled to one or more first shaft(s) 302 that rotate with the steering wheel 102. In FIG. 3, an input gear 304 is coupled to the first shaft(s) 302 and, thus, rotates with the first shaft(s) 302 and the steering wheel 102. The input gear 304 is engaged with an output gear 306. The input gear 304 and the output gear 306 include an at least partially conical shape. For example, the input gear 304 can be partially conical and include a first base 308 and a second base 310 opposite the first base 308. In the illustrated example of FIG. 3, the input gear 304 includes a trapezoidal axial cross-section. In some other examples, the input gear 304 is fully conical and, in turn, includes a triangular axial cross-section. Further, the output gear 306 includes a third base 312 and a vertex 314 opposite the third base 312. In some other examples, the output gear 306 includes a trapezoidal axial cross-section similar to the input gear 304.

In the illustrated example of FIG. 3, the steering actuator 300 includes a first servo motor or pump 316 to move (e.g., translate, axially displace, etc.) the output gear 306 to change an engagement between the input gear 304 and the output gear 306 and, in turn, a gear ratio provided by the engagement. Specifically, the gear ratio corresponds to a ratio between a first circumference of the input gear 304 and a second circumference of the output gear 306 that engages with the first circumference. The servo motor or pump 316 can adjust the gear ratio to change the steering relationship implemented by the steering actuator 300. That is, the first servo motor or pump 316 can extend or retract one or more second shaft(s) 318 coupled to the output gear 306 to adjust a portion of the output gear 306 that engages with the input gear 304. More particularly, the steering control circuitry 106 controls the servo motor or pump 316 to cause the engagement between the input gear 304 and the output gear 306 to provide a determined steering ratio between the steering wheel 102 and the steerable wheels 110. For example, the steering control circuitry 106 can cause the servo motor or pump 316 to adjust the engagement between (i) a first position in which the second base 310 aligns with the third base 312 and (ii) a second position in which the first base 308 aligns with the vertex 314. In some examples, to increase the gear ratio and the steering ratio, the steering control circuitry 106 can cause the servo motor or pump 316 to extend the second shaft(s) 318 to move the engagement closer to the first position. Alternatively, to reduce the gear ratio and the steering ratio, the steering control circuitry 106 can cause the servo motor or pump 316 to retract the second shaft(s) 318 to move the engagement closer to the second position.

In the illustrated example of FIG. 3, the input gear 304 and the output gear 306 are positioned in a housing 320 (e.g., a containment enclosure). In some examples, the housing 320 includes a lubricant to facilitate sliding of the output gear 306 along the input gear 304. In the illustrated example of FIG. 3, the first shaft(s) 302 include a first flexible joint 322 and the second shaft(s) 318 include a second flexible joint 324. The first flexible joint 322 enables a first portion 326 of the first shaft(s) 302 (e.g., a portion of the first shaft(s) 302 between the input gear 304 and the first flexible joint 322) to pivot relative to a second portion 328 of the first shaft(s) 302 (e.g., a portion of the first shaft(s) 302 between the steering wheel and the first flexible joint 322). Similarly, the second flexible joint 324 enables a first portion 330 of the second shaft(s) 318 (e.g., a portion of the second shaft(s) 318 between the output gear 306 and the second flexible joint 324) to pivot relative to a second portion 332 of the second shaft(s) 318 (e.g., a portion of the second shaft(s) 318 opposite the first portion 330).

For example, the first portion 326 and the second portion 328 of the first shaft(s) 302 can be separate shafts that are pivotably coupled at the first flexible joint 322. Similarly, the first portion 330 and the second portion 332 of the second shaft(s) 318 can be separate shafts that are pivotably coupled at the second flexible joint 324. In some examples, the first flexible joint 322 includes a biasing member (e.g., a torsion spring) to bias the second portion 328 of the first shaft(s) 302 towards the output gear 306. In some examples, the second flexible joint 324 includes a biasing member (e.g., a torsion spring) to bias the first portion 330 of the second shaft(s) 318 towards the input gear 304. As a result, the first flexible joint 322 and/or the second flexible joint 324 enable an engagement between the input gear 304 and the output gear 306 to be maintained as the servo motor or pump 316 moves the output gear 306 relative to the input gear 304.

In the illustrated example of FIG. 3, the steering actuator 300 includes a worm gear 334 that is operatively engaged with a gear system 336. For example, the second portion 332 of the second shaft(s) 318 can include the worm gear 334. As such, the worm gear 334 rotates with the output gear 306, and the gear system 336 converts the rotation of the worm gear 334 movement of the rack 338. In some examples, the gear system 336 includes a recirculating ball gear positioned around the worm gear 334 and that includes ball bearings engaged with the worm gear 334. In some of such examples, the recirculating ball gear translates as the worm gear 334 rotates. Additionally, in such examples, the gear system 336 includes another gear, such as a sector gear, that engages with the recirculating ball gear and rotates as the recirculating ball gear translates. Further, in such examples, the gear system 336 includes a pitman arm to couple an end of a shaft that includes the sector gear to a rack or drag link 338 that pivots the steerable wheels 110. Alternatively, the gear system 336 can include another gear layout and/or linkages to convert the rotation of the output gear 306 to movement of the rack or drag link 338.

In some examples, the gear system 336 includes another motor (e.g., a direct current (DC) motor, a stepper motor, a servo motor, etc.) or pump to provide additional force for steering assistance. Accordingly, the additional force can cause the output gear 306 to encounter more torque and, thus, reduce an input force that a driver provides to cause the input gear 304 to rotate the output gear 306. In some examples, the motor or pump provides a torque based on the rotation of the worm gear 334 to provide the steering assistance. In some examples, the steering control circuitry 106 is communicatively coupled to the motor or pump of the gear system 336. In some of such examples, the steering control circuitry 106 controls the motor or pump to adjust the input that the driver provides to turn the steerable wheels 110. In such examples, the steering control circuitry 106 controls a steering feel (e.g., a torque felt at the steering wheel 102).

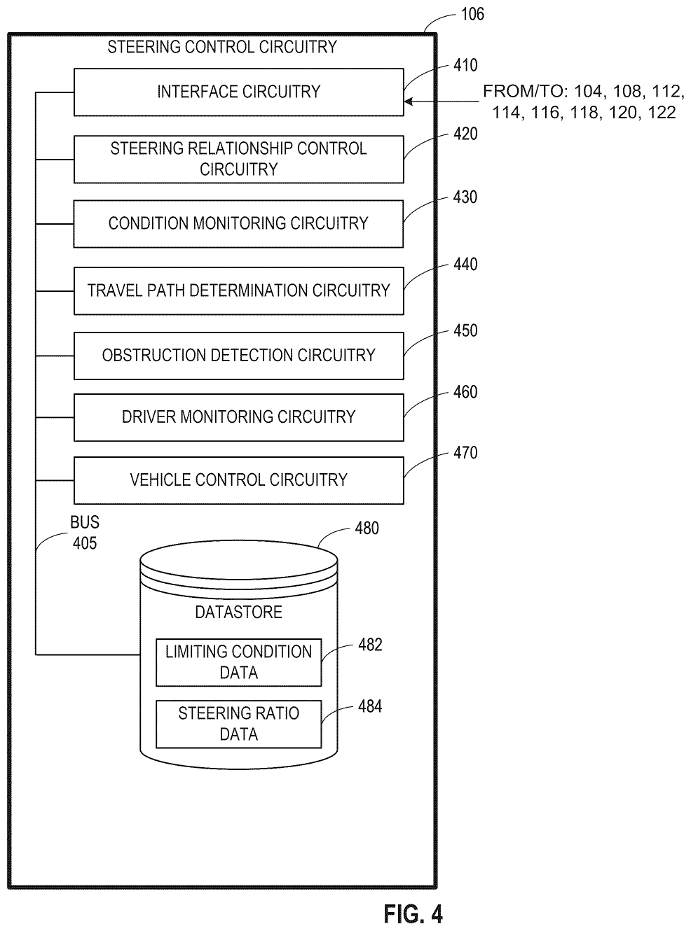

FIG. 4 is a block diagram of an example implementation of the steering control circuitry 106 of FIGS. 1, 2, and/or 3 to adjust a steering relationship between an angular rotation of the steering wheel 102 and an angular movement of the steerable wheels 110 based on a projected vehicular maneuver and/or one or more potential vehicular maneuver(s). As such, the steering control circuitry 106 reduces a range of rotation (e.g., a range of angular displacements) utilized by the steering wheel 102 to maneuver the vehicle 100. The steering control circuitry 106 of FIG. 4 may be instantiated (e.g., creating an instance of, bring into being for any length of time, materialize, implement, etc.) by programmable circuitry such as a Central Processor Unit (CPU) executing first instructions. Additionally or alternatively, the steering control circuitry 106 of FIG. 4 may be instantiated (e.g., creating an instance of, bring into being for any length of time, materialize, implement, etc.) by (i) an Application Specific Integrated Circuit (ASIC) and/or (ii) a Field Programmable Gate Array (FPGA) structured and/or configured in response to execution of second instructions to perform operations corresponding to the first instructions. It should be understood that some or all of the circuitry of FIG. 4 may, thus, be instantiated at the same or different times. Some or all of the circuitry of FIG. 4 may be instantiated, for example, in one or more threads executing concurrently on hardware and/or in series on hardware. Moreover, in some examples, some or all of the circuitry of FIG. 4 may be implemented by microprocessor circuitry executing instructions and/or FPGA circuitry performing operations to implement one or more virtual machines and/or containers.

In the illustrated example of FIG. 4, the steering control circuitry 106 includes a bus 405, interface circuitry 410, steering relationship control circuitry 420, condition monitoring circuitry 430, travel path determination circuitry 440, obstruction detection circuitry 450, driver monitoring circuitry 460, vehicle control circuitry 470, and a datastore 480. The datastore 480 includes limiting condition data 482 and steering ratio data 484. The bus 405 communicatively couples the interface circuitry 410, the steering relationship control circuitry 420, the condition monitoring circuitry 430, the travel path determination circuitry 440, the obstruction detection circuitry 450, the driver monitoring circuitry 460, the vehicle control circuitry 470, and the datastore 480.

In the illustrated example of FIG. 4, the steering control circuitry 106 includes the interface circuitry 410 to facilitate communication between the steering control circuitry 106 and the steering actuator 104, the steering sensor(s) 108, the user interface circuitry 112, the speed sensor(s) 114, the navigation circuitry 116, the external environment sensor(s) 118, the turn signal circuitry 120, and the cabin sensor(s) 122. For example, the interface circuitry 410 can be implemented by a transceiver and/or input/output (I/O) circuitry that is communicatively coupled to the steering actuator 104, the steering sensor(s) 108, the user interface circuitry 112, the speed sensor(s) 114, the navigation circuitry 116, the external environment sensor(s) 118, the turn signal circuitry 120, and the cabin sensor(s) 122.

In the illustrated example of FIG. 4, the steering control circuitry 106 includes the steering relationship control circuitry 420 to determine a steering relationship and/or a steering ratio to be utilized. For example, the steering relationship control circuitry 420 can determine the steering ratio to be utilized based on a projected travel path of the vehicle 100 (FIG. 1), the potential travel path(s) of the vehicle 100, and/or an identified limiting condition. As such, the steering relationship control circuitry 420 can determine a steering ratio that enables the vehicle 100 to follow the projected travel path and/or the potential travel path(s) with reduced input at the steering wheel 102. For example, the steering relationship control circuitry 420 can determine a steering ratio that enables the steering actuator 104 to turn the steerable wheels 110 and maneuver the vehicle 100 along the projected travel path and/or the potential travel path(s) with a steering wheel angle at the steering wheel 102 remaining less than or equal to approximately 90°. In some examples, the steering relationship control circuitry 420 identifies a projected travel path based on a route generated by the navigation circuitry 116. In some examples, the steering relationship control circuitry 420 identifies a potential travel path(s) based on data from the travel path determination circuitry 440. In some examples, the steering relationship control circuitry 420 determines the steering relationship to implement for the projected travel path and/or the potential travel path(s) based on the steering ratio data 484.

The example steering ratio data 484 can include data corresponding to vehicular maneuvers and respective steering ratios that can be implemented for the vehicular maneuvers to reduce an input to be provided at the steering wheel 102 to perform such maneuvers. In some examples, the steering ratio data 484 includes a model that correlates respective steering ratios with vehicular maneuvers. For example, the steering ratio data 484 can include a first steering ratio associated with a 90° right turn from the right traffic lane when the speed of the vehicle 100 is within a first range. Further, the steering ratio data 484 can include a second steering ratio associated with the 90° right turn from the right traffic lane when the speed of the vehicle 100 is within a second range different from the first range. The example steering ratio data 484 can include a third steering ratio for a 120° right turn from the right traffic lane. Additionally, the steering ratio data 484 can include a second steering ratio associated with a U-turn. As such, the steering relationship control circuitry 420 can identify the determined projected or potential maneuver in the steering ratio data 484 to determine the steering ratio to implement.

In some examples, the steering relationship control circuitry 420 utilizes artificial intelligence and/or machine learning to develop the steering ratio data 484 for different types of vehicles. For example, during a training phase, as the vehicle 100 follows a projected path, the steering relationship control circuitry 420 can control the steering ratio to cause the vehicle 100 to follow the projected path while maintaining the steering wheel angle within a certain range (e.g., within 90° from a straightaway heading). In turn, the steering relationship control circuitry 420 can cause the steering ratio data 484 to associate the implemented steering ratios with the vehicular maneuvers performed therewith.

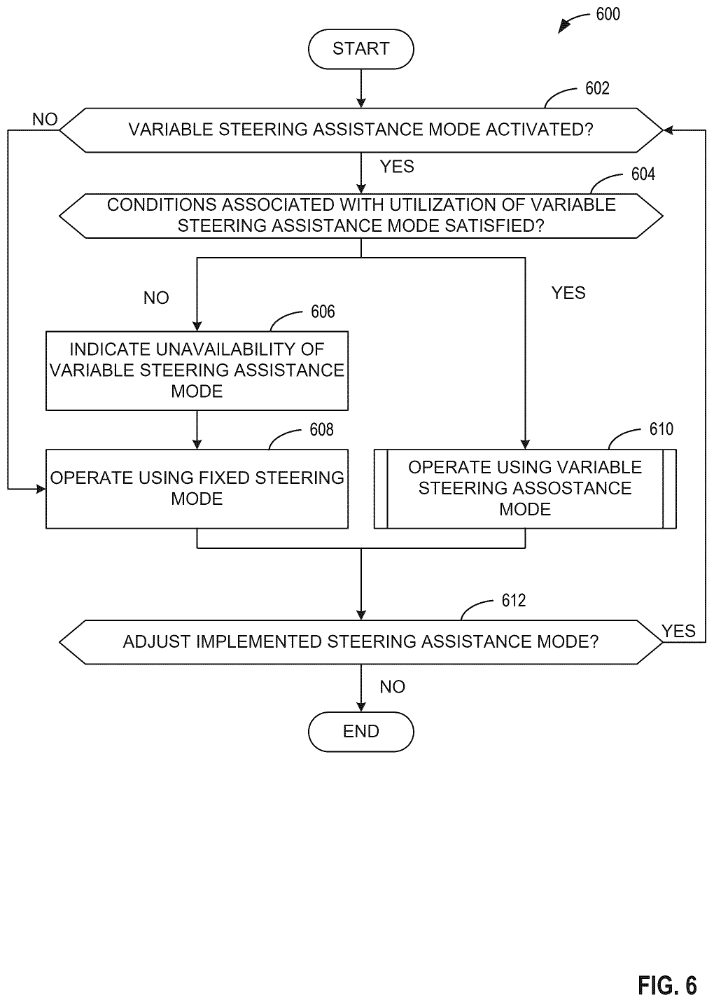

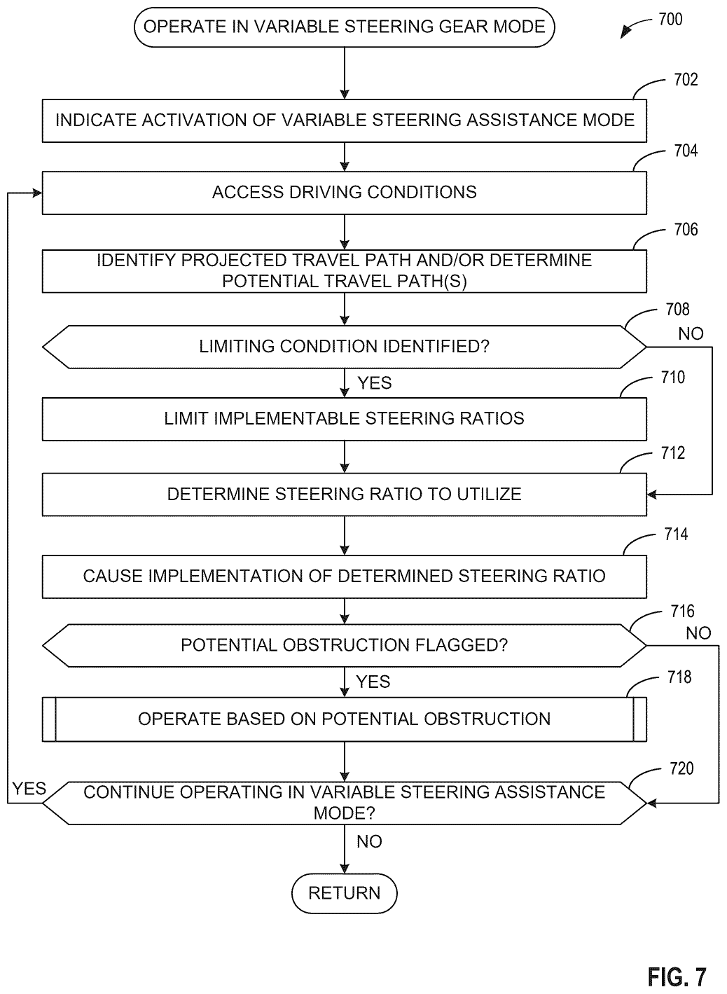

In some examples, to implement the determined steering ratio, the steering relationship control circuitry 420 causes the interface circuitry 410 to transmit a drive signal that has parameters that correspond with the determined steering ratio to the steering actuator 104. For example, the steering sensor(s) 108 can generate a first electrical signal output indicative of a movement and/or a position of the steering wheel 102. In some examples, the steering relationship control circuitry 420 adjusts a gain between the first electrical signal output and a second electrical signal that the interface circuitry 410 transmits to the steering actuator 104 (e.g., the servo motor or pump 204 (FIG. 2). For example, the steering relationship control circuitry 420 can include and/or configure a variable-gain amplifier to convert the first output signal to the second output signal to adjust the steering ratio. That is, the steering relationship control circuitry 420 adjusts a control voltage transmitted to the variable-gain amplifier to implement the gain associated with the determined steering ratio. In some examples, the steering relationship control circuitry 420 adjusts a gear configuration (e.g., a position of the output gear 306 (FIG. 3)) in the steering actuator 104 to implement the determined steering ratio. For example, the steering relationship control circuitry 420 can transmit a signal to the servo motor or pump 316 to cause the output gear 306 to move to a position in which the engagement between the input gear 304 (FIG. 3) and the output gear 306 implements the determined steering ratio. In some examples, the steering relationship control circuitry 420 determines a parameter(s) of a signal (e.g., a drive signal to the servo motor or pump 204, a control signal to the variable-gain amplifier, a control signal to the servo motor or pump 316) to be transmitted for the determined steering ratios based on the steering ratio data 484. In some examples, the steering relationship control circuitry 420 is instantiated by programmable circuitry executing steering relationship control instructions and/or configured to perform operations such as those represented by the flowchart(s) of FIGS. 6, 7, and/or 8.

In the illustrated example of FIG. 4, the steering control circuitry 106 includes the condition monitoring circuitry 430 to determine whether a movement of the vehicle 100 is associated with a limited range of steering ratios. For example, the condition monitoring circuitry 430 can compare a speed of the vehicle 100 to one or more speed thresholds in the limiting condition data 482 to identify a range permitted steering ratios that can be utilized at the speed. In some examples, the condition monitoring circuitry 430 is instantiated by programmable circuitry executing condition monitoring instructions and/or configured to perform operations such as those represented by the flowchart(s) of FIGS. 6, 7 and/or 8.

In some examples, the steering relationship control circuitry 420 limits the steering ratio based on the limiting condition and the range of permitted steering ratios identified by the condition monitoring circuitry 430. For example, when the condition monitoring circuitry 430 identifies a limiting condition, the steering relationship control circuitry 420 compares the determined steering ratio to the range of permitted steering ratios. When the determined steering ratio is within the range of permitted steering ratios, the steering relationship control circuitry 420 determines that the determined steering ratio can be utilized. When the determined steering ratio is outside the range of permitted steering ratios, the steering relationship control circuitry 420 determines a steering ratio that is closest to the determined steering ratio and that is within the range of permitted steering ratios for implementation.

In the illustrated example of FIG. 4, the steering control circuitry 106 includes the travel path determination circuitry 440 to determine one or more potential travel paths and/or a projected travel path for the vehicle 100. For example, the travel path determination circuitry 440 can determine the potential travel path(s) based on an input from the steering sensor(s) 108, the speed sensor(s) 114, the external environment sensor(s) 118, and/or the turn signal circuitry 120. For example, the travel path determination circuitry 440 can determine a geometry of the road on which the vehicle 100 is traveling and/or an intersection that the vehicle 100 is approaching based on an output of the external environment sensor(s) 118. Further, the travel path determination circuitry 440 can determine that the vehicle 100 is to make a turn when the vehicle 100 is in a corresponding traffic lane, is within a certain speed range, and/or when the turn signal circuitry 120 is activated. The example travel path determination circuitry 440 can determine the maneuver to be performed based on the determined geometry of the intersection and the speed of the vehicle 100. In some examples, the travel path determination circuitry 440 identifies the projected travel path based on a route identified by the navigation circuitry 116. The travel path determination circuitry 440 can communicate parameters associated with the projected maneuver and/or the potential maneuver to the steering relationship control circuitry 420, which can determine the steering ratio to be implemented accordingly. In some examples, the travel path determination circuitry 440 is instantiated by programmable circuitry executing travel path determination instructions and/or configured to perform operations such as those represented by the flowchart(s) of FIGS. 6, 7, and/or 8.

In the illustrated example of FIG. 4, the steering control circuitry 106 includes the obstruction detection circuitry 450 to detect obstructions in and/or around the projected path and/or the potential path(s) of the vehicle 100. For example, the obstruction detection circuitry 450 can identify an obstruction and/or a boundary of the roadway based on an input from the external environment sensor(s) 118. In some examples, the obstruction detection circuitry 450 identifies a location of the obstruction and/or boundary. The example obstruction detection circuitry 450 determines whether the potential or projected travel path(s) intersects a location of the potential obstruction. When the location of the obstruction overlaps with or is within a range of the projected path and/or the potential path(s) of the vehicle 100, the obstruction detection circuitry 450 flags the potential obstruction. In some examples, the obstruction detection circuitry 450 is instantiated by programmable circuitry executing obstruction detection instructions and/or configured to perform operations such as those represented by the flowchart(s) of FIGS. 6, 7, and/or 8.

In the illustrated example of FIG. 4, the steering control circuitry 106 includes the driver monitoring circuitry 460 to determine whether to flag a behavior of a driver of the vehicle 100 when the location of the obstruction overlaps with or is within the range of the projected path and/or the potential path(s) of the vehicle 100. For example, the driver monitoring circuitry 460 can analyze data from the cabin sensor(s) 122, which can be indicative of a position and/or a movement of the driver. Additionally or alternatively, the driver monitoring circuitry 460 can analyze data from the steering sensor(s) 108 to determine whether the driver is providing an input (e.g., a torque) at the steering wheel 102. The driver monitoring circuitry 460 can flag the behavior of the driver when there is a lack of steering input detected by the steering sensor(s) 108 (e.g., when the driver does not have their hands on the steering wheel 102), a lack of movement by the driver detected by the cabin sensor(s) 122, and/or an irregular position of the driver detected by the cabin sensor(s) 122.

In some examples, the driver monitoring circuitry 460 determines a current path of the vehicle 100 based on the speed and/or acceleration of the vehicle 100, a position and/or movement of the steering wheel angle, and the implemented steering ratio. In such examples, the driver monitoring circuitry 460 determines whether the determined path intersects the potential obstruction. In some examples, when the driver monitoring circuitry 460 determines that the determined path intersects the location of the potential obstruction, the driver monitoring circuitry 460 causes the steering relationship control circuitry 420 to determine an adjusted steering ratio that adjusts the path of the vehicle 100 in an effort to avoid the potential obstruction. In some examples, when the adjusted path of the vehicle 100 still intersects the location of the potential obstruction, the driver monitoring circuitry 460 determines that the driver is unalert or incapacitated and triggers the vehicle control circuitry 470 to take control of steering the vehicle 100. In some examples, the driver monitoring circuitry 460 is instantiated by programmable circuitry executing driver monitoring instructions and/or configured to perform operations such as those represented by the flowchart(s) of FIGS. 6, 7, and/or 8.

In the illustrated example of FIG. 4, the vehicle control circuitry 470 causes an orientation of the steering wheel 102 to be decoupled from an orientation of the steerable wheels 110. In some examples, the vehicle control circuitry 470 causes the orientation of the steerable wheels 110 to be controlled independent of a steering wheel angle measured by the steering sensor(s) 108. In some examples, the vehicle control circuitry 470 causes the output gear 306 to be disengaged with the input gear 304 to cause the steering wheel 102 to be decoupled from an orientation of the steerable wheels 110. For example, the vehicle control circuitry 470 can cause the servo motor or pump 316 to move (e.g., retract) the output gear 306 to a position in which rotation of the input gear 304 does not drive the output gear 306. In some examples, the vehicle control circuitry 470 controls the steering actuator 104 and, thus, a position of the steerable wheels 110 based on the location of the potential obstruction and the current path of the vehicle 100. In such examples, the vehicle control circuitry 470 adjusts the position of the steerable wheels 110 to cause the path of the vehicle 100 to change to avoid the potential obstruction. As such, when the driver is incapacitated or mishandling the steering ratio, the vehicle control circuitry 470 can help the vehicle 100 avoid the obstruction. In some examples, the vehicle control circuitry 470 is instantiated by programmable circuitry executing vehicle control instructions and/or configured to perform operations such as those represented by the flowchart(s) of FIGS. 6, 7, and/or 8.

While an example manner of implementing the steering control circuitry 106 of FIG. 1 is illustrated in FIG. 4, one or more of the elements, processes, and/or devices illustrated in FIG. 4 may be combined, divided, re-arranged, omitted, eliminated, and/or implemented in any other way. Further, the example interface circuitry 410, the example steering relationship control circuitry 420, the example condition monitoring circuitry 430, the example travel path determination circuitry 440, the example obstruction detection circuitry 450, the example driver monitoring circuitry 460, the example vehicle control circuitry 470, the datastore 480 including the limiting condition data 482 and the steering ratio data 484, and/or, more generally, the example steering control circuitry 106 of FIG. 4, may be implemented by hardware alone or by hardware in combination with software and/or firmware. Thus, for example, any of the example interface circuitry 410, the example steering relationship control circuitry 420, the example condition monitoring circuitry 430, the example travel path determination circuitry 440, the example obstruction detection circuitry 450, the example driver monitoring circuitry 460, the example vehicle control circuitry 470, the datastore 480 including the limiting condition data 482 and the steering ratio data 484, and/or, more generally, the example steering control circuitry 106, could be implemented by programmable circuitry in combination with machine readable instructions (e.g., firmware or software), processor circuitry, analog circuit(s), digital circuit(s), logic circuit(s), programmable processor(s), programmable microcontroller(s), graphics processing unit(s) (GPU(s)), digital signal processor(s) (DSP(s)), ASIC(s), programmable logic device(s) (PLD(s)), and/or field programmable logic device(s) (FPLD(s)) such as FPGAs. Further still, the example steering control circuitry 106 of FIG. 4 may include one or more elements, processes, and/or devices in addition to, or instead of, those illustrated in FIG. 4, and/or may include more than one of any or all of the illustrated elements, processes and devices.

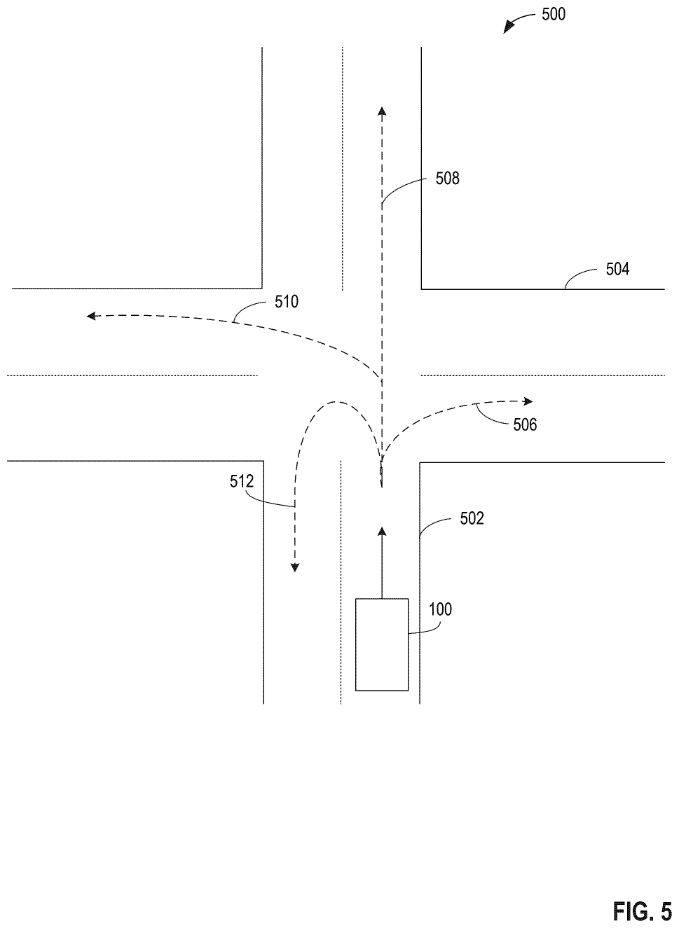

FIG. 5 is a schematic representation of example projected and/or potential travel paths for the vehicle 100 as the vehicle 100 approaches an intersection 500 between a first road 502 and a second road 504. More particularly, the vehicle 100 is on the first road 502 and approaching the second road 504. In the illustrated example of FIG. 5, a first trajectory 506 (e.g., a first maneuver, a first travel path) for the vehicle 100 includes a right turn onto the second road 504. The second trajectory 508 (e.g., a second maneuver, a second travel path) includes a straight heading in which the vehicle 100 continues on the first road 502 past the second road 504. The third trajectory 510 (e.g., a third maneuver, a third travel path) includes a left turn onto the second road 504. The fourth trajectory 512 (e.g., a fourth maneuver, a fourth travel path) includes a U-turn on an opposite side of the first road 502.

In the illustrated example of FIG. 5, as the vehicle 100 approaches the intersection, the steering control circuitry 106 identifies the first trajectory 506, the second trajectory 508, the third trajectory 510, and/or the fourth trajectory 512. In some examples, the steering control circuitry 106 determines and implements a steering ratio that enables the vehicle 100 to follow any of the first trajectory 506, the second trajectory 508, the third trajectory 510, or the fourth trajectory 512 while maintaining the steering wheel 102 within a predetermined rotational range (e.g., within a 45° rotation of the steering wheel 102 from a neutral position, within a 90° rotation of the steering wheel 102 from the neutral position, etc.).

In some examples, the steering control circuitry 106 identifies one of the trajectories 506, 508, 510, 512 the vehicle 100 will follow based on an input from the navigation circuitry 116. In such examples, the steering control circuitry 106 determines and implements a steering ratio that corresponds with the respective trajectory 506, 508, 510, 512. For example, when the vehicle 100 is to follow the first trajectory 506, the steering control circuitry 106 can determine and implement a first steering ratio that causes the vehicle 100 to travel along the first trajectory 506 while maintaining the steering wheel 102 within the predetermined rotational range. In some examples, when the vehicle 100 is to follow the second trajectory 508, the steering control circuitry 106 determines and implements a second steering ratio that is less than the first steering ratio to prevent the steering actuator 104 from being oversensitive to slight movements of the steering wheel 102 as the vehicle 100 continues straight on the second trajectory 508. In some examples, when the vehicle 100 is to follow the third trajectory 510, the steering control circuitry 106 determines and implements the first steering ratio or a third steering ratio greater than the second steering ratio that causes the vehicle 100 to travel along the third trajectory 510 while maintaining the steering wheel 102 within the predetermined rotational range. In some examples, when the vehicle 100 is to follow the fourth trajectory 512, the steering control circuitry 106 determines and implements a fourth steering ratio greater than the first, second, and third steering ratios to enable the vehicle 100 to travel along the fourth trajectory 512 while maintaining the steering wheel 102 within the predetermined rotational range. The example steering control circuitry 106 can determine the different steering ratios based on a speed of the vehicle 100 and a trajectory of the travel trajectories 506, 508, 510, 512. In some examples, when the navigation circuitry 116 does not have a route for the current trip, the steering control circuitry 106 predicts which one of the trajectories 506, 508, 510, 512 based on data from the speed sensor(s) 114, the external environment sensor(s) 118, and/or the turn signal circuitry 120.

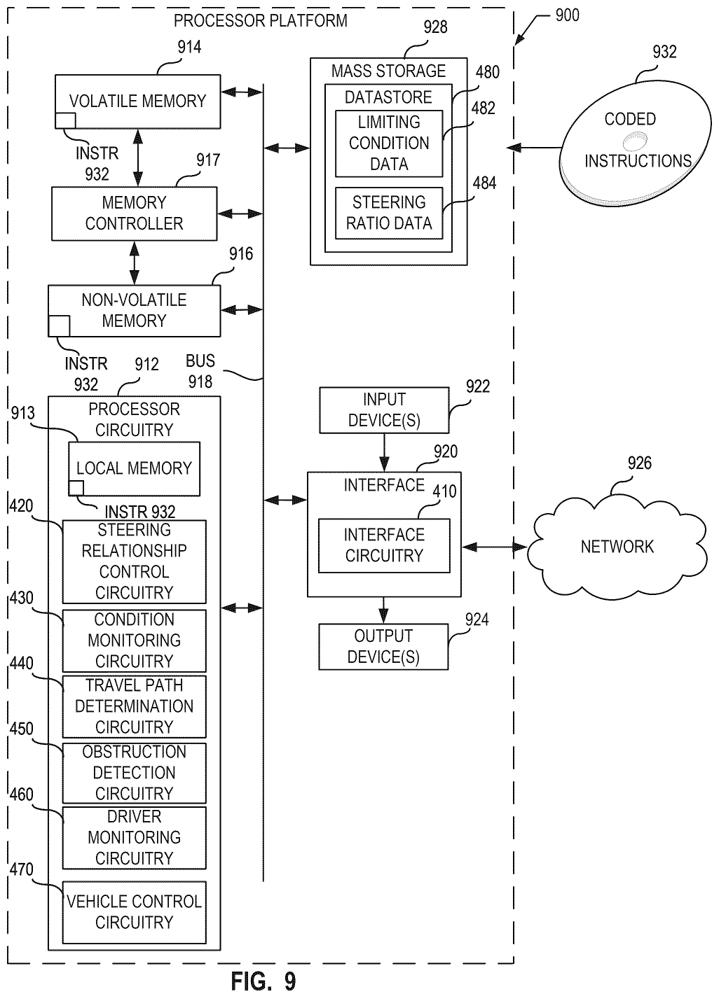

Flowcharts representative of example machine readable instructions, which may be executed by programmable circuitry to implement and/or instantiate the steering control circuitry 106 of FIG. 4 and/or representative of example operations which may be performed by programmable circuitry to implement and/or instantiate the steering control circuitry 106 of FIG. 4, are shown in FIGS. 6, 7, and 8. The machine readable instructions may be one or more executable programs or portion(s) of one or more executable programs for execution by programmable circuitry such as the programmable circuitry 912 shown in the example processor platform 900 discussed below in connection with FIG. 9 and/or may be one or more function(s) or portion(s) of functions to be performed by the example programmable circuitry (e.g., an FPGA). In some examples, the machine readable instructions cause an operation, a task, etc., to be carried out and/or performed in an automated manner in the real world. As used herein, “automated” means without human involvement.

The program may be embodied in instructions (e.g., software and/or firmware) stored on one or more non-transitory computer readable and/or machine readable storage medium such as cache memory, a magnetic-storage device or disk (e.g., a floppy disk, a Hard Disk Drive (HDD), etc.), an optical-storage device or disk (e.g., a Blu-ray disk, a Compact Disk (CD), a Digital Versatile Disk (DVD), etc.), a Redundant Array of Independent Disks (RAID), a register, ROM, a solid-state drive (SSD), SSD memory, non-volatile memory (e.g., electrically erasable programmable read-only memory (EEPROM), flash memory, etc.), volatile memory (e.g., Random Access Memory (RAM) of any type, etc.), and/or any other storage device or storage disk. The instructions of the non-transitory computer readable and/or machine readable medium may program and/or be executed by programmable circuitry located in one or more hardware devices, but the enwheel program and/or parts thereof could alternatively be executed and/or instantiated by one or more hardware devices other than the programmable circuitry and/or embodied in dedicated hardware. The machine readable instructions may be distributed across multiple hardware devices and/or executed by two or more hardware devices (e.g., a server and a client hardware device). For example, the client hardware device may be implemented by an endpoint client hardware device (e.g., a hardware device associated with a human and/or machine user) or an intermediate client hardware device gateway (e.g., a radio access network (RAN)) that may facilitate communication between a server and an endpoint client hardware device. Similarly, the non-transitory computer readable storage medium may include one or more mediums. Further, although the example program is described with reference to the flowchart(s) illustrated in FIGS. 6, 7, and 8, many other methods of implementing the example steering control circuitry 106 may alternatively be used. For example, the order of execution of the blocks of the flowchart(s) may be changed, and/or some of the blocks described may be changed, eliminated, or combined. Additionally or alternatively, any or all of the blocks of the flow chart may be implemented by one or more hardware circuits (e.g., processor circuitry, discrete and/or integrated analog and/or digital circuitry, an FPGA, an ASIC, a comparator, an operational-amplifier (op-amp), a logic circuit, etc.) structured to perform the corresponding operation without executing software or firmware. The programmable circuitry may be distributed in different network locations and/or local to one or more hardware devices (e.g., a single-core processor (e.g., a single core CPU), a multi-core processor (e.g., a multi-core CPU, an XPU, etc.)). For example, the programmable circuitry may be a CPU and/or an FPGA located in the same package (e.g., the same integrated circuit (IC) package or in two or more separate housings), one or more processors in a single machine, multiple processors distributed across multiple servers of a server rack, multiple processors distributed across one or more server racks, etc., and/or any combination(s) thereof.

The machine readable instructions described herein may be stored in one or more of a compressed format, an encrypted format, a fragmented format, a compiled format, an executable format, a packaged format, etc. Machine readable instructions as described herein may be stored as data (e.g., computer-readable data, machine-readable data, one or more bits (e.g., one or more computer-readable bits, one or more machine-readable bits, etc.), a bitstream (e.g., a computer-readable bitstream, a machine-readable bitstream, etc.), etc.) or a data structure (e.g., as portion(s) of instructions, code, representations of code, etc.) that may be utilized to create, manufacture, and/or produce machine executable instructions. For example, the machine readable instructions may be fragmented and stored on one or more storage devices, disks and/or computing devices (e.g., servers) located at the same or different locations of a network or collection of networks (e.g., in the cloud, in edge devices, etc.). The machine readable instructions may require one or more of installation, modification, adaptation, updating, combining, supplementing, configuring, decryption, decompression, unpacking, distribution, reassignment, compilation, etc., in order to make them directly readable, interpretable, and/or executable by a computing device and/or other machine. For example, the machine readable instructions may be stored in multiple parts, which are individually compressed, encrypted, and/or stored on separate computing devices, wherein the parts when decrypted, decompressed, and/or combined form a set of computer-executable and/or machine executable instructions that implement one or more functions and/or operations that may together form a program such as that described herein.

In another example, the machine readable instructions may be stored in a state in which they may be read by programmable circuitry, but require addition of a library (e.g., a dynamic link library (DLL)), a software development kit (SDK), an application programming interface (API), etc., in order to execute the machine-readable instructions on a particular computing device or other device. In another example, the machine readable instructions may need to be configured (e.g., settings stored, data input, network addresses recorded, etc.) before the machine readable instructions and/or the corresponding program(s) can be executed in whole or in part. Thus, machine readable, computer readable and/or machine readable media, as used herein, may include instructions and/or program(s) regardless of the particular format or state of the machine readable instructions and/or program(s).

The machine readable instructions described herein can be represented by any past, present, or future instruction language, scripting language, programming language, etc. For example, the machine readable instructions may be represented using any of the following languages: C, C++, Java, C#, Perl, Python, JavaScript, HyperText Markup Language (HTML), Structured Query Language (SQL), Swift, etc.

As mentioned above, the example operations of FIGS. 6, 7, and 8 may be implemented using executable instructions (e.g., computer readable and/or machine readable instructions) stored on one or more non-transitory computer readable and/or machine readable media. As used herein, the terms non-transitory computer readable medium, non-transitory computer readable storage medium, non-transitory machine readable medium, and/or non-transitory machine readable storage medium are expressly defined to include any type of computer readable storage device and/or storage disk and to exclude propagating signals and to exclude transmission media. Examples of such non-transitory computer readable medium, non-transitory computer readable storage medium, non-transitory machine readable medium, and/or non-transitory machine readable storage medium include optical storage devices, magnetic storage devices, an HDD, a flash memory, a read-only memory (ROM), a CD, a DVD, a cache, a RAM of any type, a register, and/or any other storage device or storage disk in which information is stored for any duration (e.g., for extended time periods, permanently, for brief instances, for temporarily buffering, and/or for caching of the information). As used herein, the terms “non-transitory computer readable storage device” and “non-transitory machine readable storage device” are defined to include any physical (mechanical, magnetic and/or electrical) hardware to retain information for a time period, but to exclude propagating signals and to exclude transmission media. Examples of non-transitory computer readable storage devices and/or non-transitory machine readable storage devices include random access memory of any type, read only memory of any type, solid state memory, flash memory, optical discs, magnetic disks, disk drives, and/or redundant array of independent disks (RAID) systems. As used herein, the term “device” refers to physical structure such as mechanical and/or electrical equipment, hardware, and/or circuitry that may or may not be configured by computer readable instructions, machine readable instructions, etc., and/or manufactured to execute computer-readable instructions, machine-readable instructions, etc.

FIG. 6 is a flowchart representative of example machine readable instructions and/or example operations 600 that may be executed, instantiated, and/or performed by programmable circuitry to control a steering assistance utilized by a vehicle. The example machine-readable instructions and/or the example operations 600 of FIG. 6 begin at block 602, at which the vehicle 100 (FIG. 1) determines whether a variable steering assistance mode is activated. For example, the steering control circuitry 106 (FIG. 1) can determine whether the variable steering assistance mode is activated based on an input received via the user interface circuitry 112 (FIG. 1). In some examples, the interface circuitry 410 (FIG. 4) accesses and/or receives an indication that the variable steering assistance mode is activated or deactivated from the user interface circuitry 112. In such examples, the steering relationship control circuitry 420 (FIG. 4) determines whether the variable steering assistance mode is activated or deactivated based on information received and/or accessed by the interface circuitry 410. When the variable steering assistance mode is activated, the operations 600 proceed to block 604. Otherwise, when the variable steering assistance mode is not activated, the operations 600 proceed to block 608.

At block 604, the vehicle 100 determines whether conditions associated with utilization of the variable steering assistance mode are satisfied. For example, the steering control circuitry 106 can determine whether the conditions are satisfied based on one or more signal(s) from the steering sensor(s) 108 (FIG. 1), the speed sensor(s) 114 (FIG. 1), the navigation circuitry 116 (FIG. 1), the external environment sensor(s) 118 (FIG. 1), and/or the cabin sensor(s) 122 (FIG. 1). In some examples, the condition monitoring circuitry 430 (FIG. 4) determines whether the conditions are satisfied. In some examples, the conditions include a speed threshold to be satisfied for the variable steering assistance mode to be utilized. In such examples, the speed sensor(s) 114 measure a speed of the vehicle 100. Further, the condition monitoring circuitry 430 compares the speed to the speed threshold. When the speed of the vehicle 100 satisfies (e.g., is less than, is less than or equal to) the speed threshold, the condition monitoring circuitry 430 determines that at least one of the conditions is satisfied. When the speed of the vehicle 100 does not satisfy (e.g., is greater than or equal to, is greater than) the speed threshold, the condition monitoring circuitry 430 determines that at least one of the conditions is not satisfied. When a condition associated with utilization of the variable steering assistance mode is not satisfied, the operations 600 proceed to block 606. Otherwise, when the conditions associated with utilization of the variable steering assistance mode are satisfied, the operations 600 proceed to block 612. In some examples, when the operations 600 proceed to block 612, the condition monitoring circuitry 430 repeatedly performs the operations of block 604 to assess whether the conditions associated with utilization of the variable steering assistance mode remain satisfied during utilization of the variable steering assistance mode.

At block 606, the vehicle 100 indicates an unavailability of the variable steering assistance mode. For example, the steering control circuitry 106 can cause the user interface circuitry 112 to visually, audibly, and/or haptically indicate that the variable steering assistance mode is unavailable. In some examples, the condition monitoring circuitry 430 causes the interface circuitry 410 to transmit a signal indicative of the variable steering assistance mode being unavailable. In some examples, the steering control circuitry 106 causes the user interface circuitry 112 to indicate which condition was not satisfied to cause the variable steering assistance mode to be unavailable.

At block 608, the vehicle 100 operates using a fixed steering mode. For example, the steering control circuitry 106 can cause the steering relationship to operate in a preset state (e.g., a factory setting, a no relative gain state) in which a particular position or movement of the steering wheel 102 corresponds with a particular position or movement of the steerable wheels 110, as opposed to the variable steering assistance mode in which a particular position or movement of the steering wheel 102 can correspond with different positions or movements of the steerable wheels 110. In some examples, the steering relationship control circuitry 420 causes the steering relationship to be in the preset state. After block 608, the operations 600 proceed to block 612.

At block 610, the vehicle 100 operates using the variable steering assistance mode. For example, the steering control circuitry 106 can adjust the steering relationship between the steering wheel 102 and the steerable wheels 110. Example operations and/or machine readable instructions that may be used to implement block 610 are described below in conjunction with FIG. 7.

At block 612, the vehicle 100 determines whether to adjust the implemented steering assistance mode. For example, the steering control circuitry 106 can determine whether a selected steering assistance mode at the user interface circuitry 112 is changed. Additionally or alternatively, the steering control circuitry 106 can determine that a previously unsatisfied condition associated with utilization of the variable steering assistance mode is now satisfied. Conversely, the steering control circuitry 106 can determine that a previously satisfied condition associated with utilization of the variable steering assistance mode is no longer satisfied. When the implemented steering assistance mode is to be adjusted, the operations 600 return to block 602. Otherwise, when the implemented steering assistance mode is not to be adjusted, the operations 600 terminate.

FIG. 7 is a flowchart representative of example machine readable instructions and/or example operations 700 that may be executed, instantiated, and/or performed by programmable circuitry to implement block 610 of FIG. 6 to control a steering relationship in the variable steering assistance mode. The example machine-readable instructions and/or the example operations 700 of FIG. 7 begin at block 702, at which the vehicle 100 (FIG. 1) indicates activation of the variable steering assistance mode. For example, the steering control circuitry 106 (FIG. 1) can cause the user interface circuitry 112 to visually, audibly, and/or haptically indicate that the variable steering assistance mode is active.

At block 704, the vehicle 100 accesses driving conditions. For example, the steering control circuitry 106 can access driving information detected or identified by the steering sensor(s) 108 (FIG. 1), the speed sensor(s) 114 (FIG. 1), the navigation circuitry 116 (FIG. 1), the external environment sensor(s) 118 (FIG. 1), and/or the turn signal circuitry 120 (FIG. 1). In some examples, the steering control circuitry 106 identifies a steering wheel angle and/or a change in the steering wheel angle (e.g., a rotation of the steering wheel) based on data from the steering sensor(s) 108. In some examples, the steering control circuitry 106 identifies a speed of the vehicle 100 based on data from the speed sensor(s) 114. In some examples, the steering control circuitry 106 identifies a projected travel path of the vehicle 100 based on data from the navigation circuitry 116. In some examples, the steering control circuitry 106 identifies information associated with the environment in which the vehicle 100 is located based on data from the external environment sensor(s) 118. For example, the data from the external environment sensor(s) 118 can be indicative of obstructions in the environment, a location of the vehicle 100 on a road (e.g., a traffic lane where the vehicle 100 is located, an intersection in which the vehicle 100 is located or that the vehicle 100 is approaching, etc.), and/or a geometry of the road. In some examples, the steering control circuitry 106 identifies an activation of a right or left turn signal based on data from the turn signal circuitry 120. In some examples, the interface circuitry 410 (FIG. 4) accesses the driving information from the steering sensor(s) 108, the speed sensor(s) 114, the navigation circuitry 116, the external environment sensor(s) 118, and/or the turn signal circuitry 120.

At block 706, the vehicle 100 identifies a projected travel path and/or determines one or more potential travel paths. For example, the steering control circuitry 106 can identify the projected travel path and/or determine the potential travel path(s). In some examples, the travel path determination circuitry 440 (FIG. 4) identifies the projected travel path based on a route identified by the navigation circuitry 116. In some examples, the travel path determination circuitry 440 determines the potential travel path(s) based on data from the steering sensor(s) 108, the speed sensor(s) 114, the external environment sensor(s) 118, and/or the turn signal circuitry 120.

At block 708, the vehicle 100 determines whether a limiting condition is identified. For example, the steering control circuitry 106 can determine whether the vehicle 100 is encountering a condition that corresponds with limiting a steering ratio to be implemented by the steering control circuitry 106. In some examples, the condition monitoring circuitry 430 determines whether the vehicle 100 is encountering a limiting condition. For example, the condition monitoring circuitry 430 can determine whether the driving conditions correspond with a limiting condition in the limiting condition data 482 (FIG. 4) of the datastore 480 (FIG. 4). In some examples, the condition monitoring circuitry 430 determines that the speed of the vehicle 100 does not satisfy one or more speed thresholds in the limiting condition data 482 associated with limiting the steering ratio to be implemented. When a limiting condition is identified, the operations 700 proceed to block 710. Otherwise, when a limiting condition is not identified, the operations skip to block 712.

At block 710, the vehicle 100 limits implementable steering ratios. For example, the steering control circuitry 106 can limit the steering ratio based on the identified limiting condition. In some examples, the condition monitoring circuitry 430 determines the limit to the implementable steering ratio based on the limiting condition data 482. For example, when the limiting condition data 482 can include a maximum implementable steering ratio associated with a speed threshold. As such, when the speed of the vehicle 100 does not satisfy (e.g., is greater than, is greater than or equal to) the speed threshold, the condition monitoring circuitry 430 can identify the maximum implementable steering ratio associated with not satisfying the speed threshold. In some examples, the condition monitoring circuitry 430 communicates a threshold (e.g., a maximum) usable steering ratio and/or a range of usable steering ratios to the steering relationship control circuitry 420.

At block 712, the vehicle 100 determines a steering ratio to utilize. For example, the steering control circuitry 106 can determine the steering ratio to be implemented based on the driving conditions and/or an identified limiting condition. In some examples, the steering relationship control circuitry 420 determines the steering ratio based on the projected travel path, the potential travel path(s), and/or an identified limiting condition. The example steering relationship control circuitry 420 can determine a steering ratio that enables the vehicle 100 to follow the projected travel path and/or the potential travel path(s) with reduced input at the steering wheel 102. For example, the steering relationship control circuitry 420 can determine a steering ratio that enables the steering wheel 102 to turn the steerable wheels 110 and maneuver the vehicle 100 along the projected travel path and/or the potential travel path(s) with a steering wheel angle less than or equal to approximately 90°. When the condition monitoring circuitry 430 has identified a limiting condition, the example steering relationship control circuitry 420 compares the determined steering ratio to the threshold usable steering ratio and/or the range of usable steering ratios. When the determined steering ratio satisfies (e.g., is less than or equal to, is less than) the threshold usable steering ratio and/or is within the range of usable steering ratios, the steering relationship control circuitry 420 determines that the determined steering ratio can be utilized. When the determined steering ratio does not satisfy (e.g., is greater than, is greater than or equal to) the threshold usable steering ratio and/or is outside the range of usable steering ratios, the steering relationship control circuitry 420 determines a steering ratio that is closest to the determined steering ratio and that satisfies the threshold usable steering ratio and/or is within the range of usable steering ratios.

At block 714, the vehicle 100 causes implementation of the determined steering ratio. For example, the steering control circuitry 106 can cause the implementation of the determined steering ratio. In some examples, the steering relationship control circuitry 420 determines a drive signal to be transmitted to the steering actuator 104 (e.g., the servo motor or pump 204 (FIG. 2) of the steering actuator 200 (FIG. 2)) based on the determined steering ratio and a rotation of the steering wheel 102 detected by the steering sensor(s) 108. In such examples, the steering relationship control circuitry 420 causes the interface circuitry 410 to transmit the determined drive signal to the steering actuator 104. In some examples, the steering relationship control circuitry 420 determines a gear ratio to be utilized to implement the determined steering ratio. In such examples, the steering relationship control circuitry 420 causes the interface circuitry 410 to transmit a signal to the servo motor or pump 316 (FIG. 3) to adjust an engagement between the input gear 304 and the output gear 306 and, in turn, cause the determined gear ratio to be implemented.

At block 716, the vehicle 100 determines whether a potential obstruction is flagged. For example, the steering control circuitry 106 can determine whether the external environment sensor(s) 118 have identified an obstruction in the projected path and/or the potential path(s) of the vehicle 100. In some examples, the obstruction detection circuitry 450 (FIG. 4) identifies an obstruction in or near the projected path and/or the potential path(s) of the vehicle 100. In some examples, the obstruction detection circuitry 450 (FIG. 4) identifies a location of the obstruction (e.g., a curb) identified by the external environment sensor(s) 118. In such examples, the obstruction detection circuitry 450 compares the location of the obstruction to the projected path and/or the potential path(s) of the vehicle 100. When the location of the obstruction overlaps with or is within a range of the projected path and/or the potential path(s) of the vehicle 100, the obstruction detection circuitry 450 flags the potential obstruction. When the potential obstruction is flagged, the operations 700 proceed to block 718. Otherwise, when no potential obstruction is flagged, the operations 700 skip to block 720.

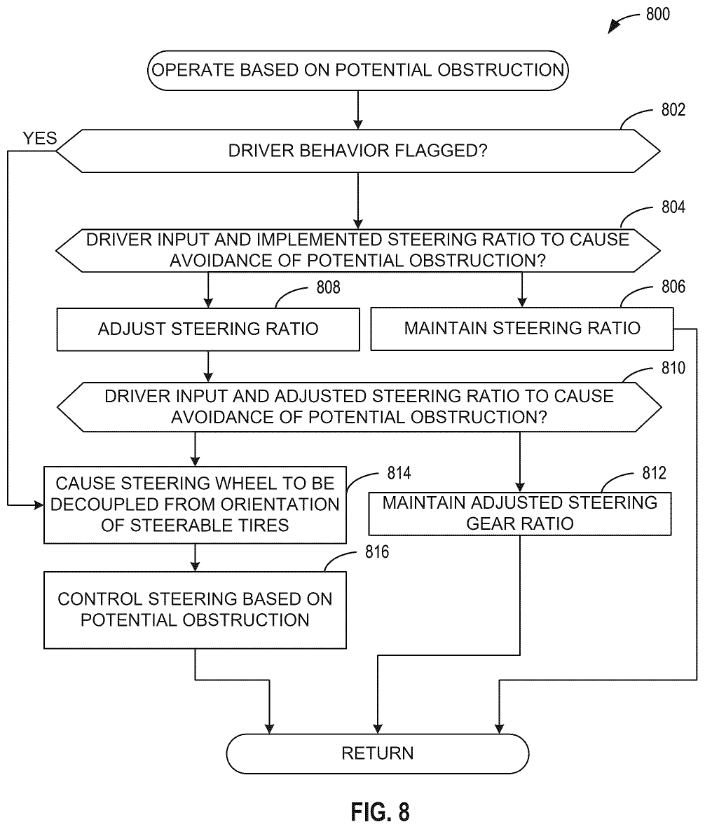

At block 718, the vehicle 100 operates based on the potential obstruction. For example, the steering control circuitry 106 can adjust the steering relationship between the steering wheel 102 and the steerable wheels 110 based on the potential obstruction. Example operations and/or machine readable instructions that may be used to implement block 718 are described below in conjunction with FIG. 8.

At block 720, the vehicle 100 determines whether to continue operating in the variable steering assistance mode. For example, the steering control circuitry 106 can determine whether to continue operating in the variable steering assistance mode based on an input received via the user interface circuitry 112 and/or the potential obstruction. When the vehicle 100 is to continue operating the in the variable steering assistance mode, the operations 700 return to block 704. Otherwise, the operations 700 terminate and control returns to the example operations 600 of FIG. 6.

FIG. 8 is a flowchart representative of example machine readable instructions and/or example operations 800 that may be executed, instantiated, and/or performed by programmable circuitry to implement block 718 of FIG. 7 to operate in the variable steering assistance mode based on a potential obstruction in the projected path and/or the potential path(s) of the vehicle 100. The example machine-readable instructions and/or the example operations 800 of FIG. 7 begin at block 802, at which the vehicle 100 (FIG. 1) determines whether a behavior of a driver is flagged. For example, the steering control circuitry 106 (FIG. 1) can flag the behavior of the driver when the driver is incapacitated. In some examples, the driver monitoring circuitry 460 (FIG. 4) determines whether the driver is incapacitated based on measurements by the cabin sensor(s) 122 (FIG. 1) and/or the steering sensor(s) 108 (FIG. 1). For example, the driver monitoring circuitry 460 can flag the behavior of the driver when there is a lack of steering input detected by the steering sensor(s) 108 (e.g., when the driver does not have their hands on the steering wheel 102), a lack of movement by the driver detected by the cabin sensor(s) 122, and/or an irregular position of the driver detected by the cabin sensor(s) 122. When the behavior of the driver is flagged, the operations 800 skip to block 816. Otherwise, when the behavior of the driver is not flagged, the operations 800 proceed to block 804.

At block 804, the vehicle 100 determines whether a driver input and the implemented steering ratio will cause the vehicle 100 to avoid the detected potential obstruction (e.g., the potential obstruction flagged at block 716 of FIG. 7). For example, the steering control circuitry 106 can determine a path that the vehicle 100 will follow if the driver does not change their input based on a measurements by the steering sensor(s) 108, a measurement by the speed sensor(s) 114 (FIG. 1), and the implemented steering ratio. In some examples, the driver monitoring circuitry 460 determines the path of the vehicle 100 based on a speed or acceleration of the vehicle 100, a position or rate of change of the steering wheel angle, and the implemented steering ratio. In such examples, the driver monitoring circuitry 460 determines whether the determined path intersects the potential obstruction. When the driver input and the implemented steering ratio will cause the vehicle 100 to avoid the potential obstruction, the operations 800 proceed to block 806. Otherwise, when the driver input and the implemented steering ratio will not cause the vehicle 100 to avoid the potential obstruction, the operations 800 proceed to block 808.

At block 806, the vehicle 100 maintains the implemented steering ratio. For example, the steering control circuitry 106 can maintain the implemented steering ratio to cause the vehicle 100 to continue on the determined path and avoid the potential obstruction. After block 806, the machine readable instructions 800 terminate and control returns to the example operations 700 of FIG. 7.

At block 808, the vehicle 100 adjusts the steering ratio. For example, the steering control circuitry 106 can adjust the steering ratio to change the path of the vehicle 100. In some examples, the driver monitoring circuitry 460 determines an adjusted steering ratio that adjusts the path of the vehicle 100 in an effort to avoid the potential obstruction. For example when the obstruction detection circuitry 450 determines that the vehicle 100 is on a path that will cause the vehicle 100 to brush a curb, the driver monitoring circuitry 460 can determine a reduction to the steering ratio that would adjust the path of the vehicle 100 such that the path does not intersect the curb.

At block 810, the vehicle 100 determines whether the driver input in conjunction with the adjusted steering ratio will cause avoidance of the potential obstruction. For example, the steering control circuitry 106 can determine an updated path of the vehicle 100 based on the driver input and the adjusted steering ratio. Further, the steering control circuitry 106 can determine whether the updated path intersects the potential obstruction. In some examples, the driver monitoring circuitry 460 determines the updated path and whether the updated path intersects the potential obstruction. When the driver input in conjunction with the adjusted steering ratio will cause avoidance of the potential obstruction (e.g., when the updated path does not intersect the potential obstruction), the operations 800 proceed to block 812. Otherwise, when the driver input in conjunction with the adjusted steering ratio will not cause avoidance of the potential obstruction (e.g., when the updated path intersects the potential obstruction), the operations 800 proceed to block 814.

At block 812, the vehicle 100 maintains the adjusted steering ratio. For example, the steering control circuitry 106 can maintain the adjusted steering ratio to cause the vehicle 100 to continue on the updated path and avoid the potential obstruction. After block 812, the machine readable instructions 800 terminate and control returns to the example operations 700 of FIG. 7.

At block 814, the vehicle 100 causes the steering wheel 102 to be decoupled from an orientation of the steerable wheels 110. For example, the steering control circuitry 106 can prevent the steering wheel angle from affecting the orientation of the steerable wheels 110. In some examples, the vehicle control circuitry 470 (FIG. 4) causes the orientation of the steerable wheels 110 to be controlled independent of a steering wheel angle measured by the steering sensor(s) 108. In some examples, the vehicle control circuitry 470 causes the output gear 306 (FIG. 3) to be disengaged with the input gear 304 (FIG. 3) to cause the steering wheel 102 to be decoupled from an orientation of the steerable wheels 110. For example, the vehicle control circuitry 470 can cause the servo motor or pump 316 (FIG. 3) to move (e.g., retract) the output gear 306 to a position in which rotation of the input gear 304 does not drive the output gear 306.

At block 816, the vehicle 100 controls steering based on the potential obstruction. For example, the steering control circuitry 106 can take control of steering the vehicle 100. In some examples, the vehicle control circuitry 470 controls the steering actuator 104 and, thus, a position of the steerable wheels 110. In such examples, the vehicle control circuitry 470 adjusts the position of the steerable wheels 110 to cause the path of the vehicle 100 to change to avoid the potential obstruction. As such, when the driver is incapacitated or mishandling the steering ratio, the vehicle control circuitry 470 can help the vehicle 100 avoid the obstruction. After block 816, the machine readable instructions 800 terminate and control returns to the example operations 700 of FIG. 7.

FIG. 9 is a block diagram of an example programmable circuitry platform 900 structured to execute and/or instantiate the example machine-readable instructions and/or the example operations of FIGS. 6, 7, and 8 to implement the steering control circuitry 106 of FIG. 4. The programmable circuitry platform 900 can be, for example, a self-learning machine (e.g., a neural network), or any other type of computing and/or electronic device.

The programmable circuitry platform 900 of the illustrated example includes programmable circuitry 912. The programmable circuitry 912 of the illustrated example is hardware. For example, the programmable circuitry 912 can be implemented by one or more integrated circuits, logic circuits, FPGAs, microprocessors, CPUs, GPUs, DSPs, and/or microcontrollers from any desired family or manufacturer. The programmable circuitry 912 may be implemented by one or more semiconductor based (e.g., silicon based) devices. In this example, the programmable circuitry 912 implements the steering relationship control circuitry 420, the condition monitoring circuitry 430, the travel path determination circuitry 440, the obstruction detection circuitry 450, the driver monitoring circuitry 460, and the vehicle control circuitry 460.

The programmable circuitry 912 of the illustrated example includes a local memory 913 (e.g., a cache, registers, etc.). The programmable circuitry 912 of the illustrated example is in communication with main memory 914, 916, which includes a volatile memory 914 and a non-volatile memory 916, by a bus 918. The volatile memory 914 may be implemented by Synchronous Dynamic Random Access Memory (SDRAM), Dynamic Random Access Memory (DRAM), RAMBUS® Dynamic Random Access Memory (RDRAM®), and/or any other type of RAM device. The non-volatile memory 916 may be implemented by flash memory and/or any other desired type of memory device. Access to the main memory 914, 916 of the illustrated example is controlled by a memory controller 917. In some examples, the memory controller 917 may be implemented by one or more integrated circuits, logic circuits, microcontrollers from any desired family or manufacturer, or any other type of circuitry to manage the flow of data going to and from the main memory 914, 916.

The programmable circuitry platform 900 of the illustrated example also includes interface circuitry 920. The interface circuitry 920 may be implemented by hardware in accordance with any type of interface standard, such as an Ethernet interface, a universal serial bus (USB) interface, a Bluetooth® interface, a near field communication (NFC) interface, a Peripheral Component Interconnect (PCI) interface, and/or a Peripheral Component Interconnect Express (PCIe) interface.

In the illustrated example, one or more input devices 922 are connected to the interface circuitry 920. The input device(s) 922 permit(s) a user (e.g., a human user, a machine user, etc.) to enter data and/or commands into the programmable circuitry 912. The input device(s) 922 can be implemented by, for example, a receiver, an audio sensor, a microphone, a camera (still or video), a keyboard, a button, a mouse, a touchscreen, a trackpad, a trackball, an isopoint device, and/or a voice recognition system.

One or more output devices 924 are also connected to the interface circuitry 920 of the illustrated example. The output device(s) 924 can be implemented, for example, by a transmitter, display devices (e.g., a light emitting diode (LED), an organic light emitting diode (OLED), a liquid crystal display (LCD), a cathode ray tube (CRT) display, an in-place switching (IPS) display, a touchscreen, etc.), a tactile output device, a printer, and/or speaker. The interface circuitry 920 of the illustrated example, thus, typically includes a graphics driver card, a graphics driver chip, and/or graphics processor circuitry such as a GPU.

The interface circuitry 920 of the illustrated example also includes a communication device such as a transmitter, a receiver, a transceiver, a modem, a residential gateway, a wireless access point, and/or a network interface to facilitate exchange of data with external machines (e.g., computing devices of any kind) by a network 926. The communication can be by, for example, an Ethernet connection, a digital subscriber line (DSL) connection, a telephone line connection, a coaxial cable system, a satellite system, a beyond-line-of-sight wireless system, a line-of-sight wireless system, a cellular telephone system, an optical connection, etc. In this example, the interface circuitry 920 implements the interface circuitry 410.

The programmable circuitry platform 900 of the illustrated example also includes one or more mass storage discs or devices 928 to store firmware, software, and/or data. Examples of such mass storage discs or devices 928 include magnetic storage devices (e.g., floppy disk, drives, HDDs, etc.), optical storage devices (e.g., Blu-ray disks, CDs, DVDs, etc.), RAID systems, and/or solid-state storage discs or devices such as flash memory devices and/or SSDs. In this examples, the mass storage device(s) 928 implement the datastore 480 including the limiting condition data 482 and the steering ratio data 484.

The machine readable instructions 932, which may be implemented by the machine readable instructions of FIGS. 6, 7, and 8, may be stored in the mass storage device 928, in the volatile memory 914, in the non-volatile memory 916, and/or on at least one non-transitory computer readable storage medium such as a CD or DVD which may be removable.

“Including” and “comprising” (and all forms and tenses thereof) are used herein to be open ended terms. Thus, whenever a claim employs any form of “include” or “comprise” (e.g., comprises, includes, comprising, including, having, etc.) as a preamble or within a claim recitation of any kind, it is to be understood that additional elements, terms, etc., may be present without falling outside the scope of the corresponding claim or recitation. As used herein, when the phrase “at least” is used as the transition term in, for example, a preamble of a claim, it is open-ended in the same manner as the term “comprising” and “including” are open ended. The term “and/or” when used, for example, in a form such as A, B, and/or C refers to any combination or subset of A, B, C such as (1) A alone, (2) B alone, (3) C alone, (4) A with B, (5) A with C, (6) B with C, or (7) A with B and with C. As used herein in the context of describing structures, components, items, objects and/or things, the phrase “at least one of A and B” is intended to refer to implementations including any of (1) at least one A, (2) at least one B, or (3) at least one A and at least one B. Similarly, as used herein in the context of describing structures, components, items, objects and/or things, the phrase “at least one of A or B” is intended to refer to implementations including any of (1) at least one A, (2) at least one B, or (3) at least one A and at least one B. As used herein in the context of describing the performance or execution of processes, instructions, actions, activities, etc., the phrase “at least one of A and B” is intended to refer to implementations including any of (1) at least one A, (2) at least one B, or (3) at least one A and at least one B. Similarly, as used herein in the context of describing the performance or execution of processes, instructions, actions, activities, etc., the phrase “at least one of A or B” is intended to refer to implementations including any of (1) at least one A, (2) at least one B, or (3) at least one A and at least one B.

As used herein, singular references (e.g., “a”, “an”, “first”, “second”, etc.) do not exclude a plurality. The term “a” or “an” object, as used herein, refers to one or more of that object. The terms “a” (or “an”), “one or more”, and “at least one” are used interchangeably herein. Furthermore, although individually listed, a plurality of means, elements, or actions may be implemented by, e.g., the same entity or object. Additionally, although individual features may be included in different examples or claims, these may possibly be combined, and the inclusion in different examples or claims does not imply that a combination of features is not feasible and/or advantageous.

As used herein, unless otherwise stated, the term “above” describes the relationship of two parts relative to Earth. A first part is above a second part, if the second part has at least one part between Earth and the first part. Likewise, as used herein, a first part is “below” a second part when the first part is closer to the Earth than the second part. As noted above, a first part can be above or below a second part with one or more of: other parts therebetween, without other parts therebetween, with the first and second parts touching, or without the first and second parts being in direct contact with one another.

As used in this patent, stating that any part (e.g., a layer, film, area, region, or plate) is in any way on (e.g., positioned on, located on, disposed on, or formed on, etc.) another part, indicates that the referenced part is either in contact with the other part, or that the referenced part is above the other part with one or more intermediate part(s) located therebetween.

As used herein, connection references (e.g., attached, coupled, connected, and joined) may include intermediate members between the elements referenced by the connection reference and/or relative movement between those elements unless otherwise indicated. As such, connection references do not necessarily infer that two elements are directly connected and/or in fixed relation to each other. As used herein, stating that any part is in “contact” with another part is defined to mean that there is no intermediate part between the two parts.

Unless specifically stated otherwise, descriptors such as “first,” “second,” “third,” etc., are used herein without imputing or otherwise indicating any meaning of priority, physical order, arrangement in a list, and/or ordering in any way, but are merely used as labels and/or arbitrary names to distinguish elements for ease of understanding the disclosed examples. In some examples, the descriptor “first” may be used to refer to an element in the detailed description, while the same element may be referred to in a claim with a different descriptor such as “second” or “third.” In such instances, it should be understood that such descriptors are used merely for identifying those elements distinctly within the context of the discussion (e.g., within a claim) in which the elements might, for example, otherwise share a same name.

As used herein, “approximately” and “about” modify their subjects/values to recognize the potential presence of variations that occur in real world applications. For example, “approximately” and “about” may modify dimensions that may not be exact due to manufacturing tolerances and/or other real world imperfections as will be understood by persons of ordinary skill in the art. For example, “approximately” and “about” may indicate such dimensions may be within a tolerance range of +/−10% unless otherwise specified herein.

As used herein “substantially real time” refers to occurrence in a near instantaneous manner recognizing there may be real world delays for computing time, transmission, etc. Thus, unless otherwise specified, “substantially real time” refers to real time+1 second.

As used herein, the phrase “in communication,” including variations thereof, encompasses direct communication and/or indirect communication through one or more intermediary components, and does not require direct physical (e.g., wired) communication and/or constant communication, but rather additionally includes selective communication at periodic intervals, scheduled intervals, aperiodic intervals, and/or one-time events.

As used herein, “programmable circuitry” is defined to include (i) one or more special purpose electrical circuits (e.g., an application specific circuit (ASIC)) structured to perform specific operation(s) and including one or more semiconductor-based logic devices (e.g., electrical hardware implemented by one or more transistors), and/or (ii) one or more general purpose semiconductor-based electrical circuits programmable with instructions to perform specific functions(s) and/or operation(s) and including one or more semiconductor-based logic devices (e.g., electrical hardware implemented by one or more transistors). Examples of programmable circuitry include programmable microprocessors such as Central Processor Units (CPUs) that may execute first instructions to perform one or more operations and/or functions, Field Programmable Gate Arrays (FPGAs) that may be programmed with second instructions to cause configuration and/or structuring of the FPGAs to instantiate one or more operations and/or functions corresponding to the first instructions, Graphics Processor Units (GPUs) that may execute first instructions to perform one or more operations and/or functions, Digital Signal Processors (DSPs) that may execute first instructions to perform one or more operations and/or functions, XPUs, Network Processing Units (NPUs) one or more microcontrollers that may execute first instructions to perform one or more operations and/or functions and/or integrated circuits such as Application Specific Integrated Circuits (ASICs). For example, an XPU may be implemented by a heterogeneous computing system including multiple types of programmable circuitry (e.g., one or more FPGAs, one or more CPUs, one or more GPUs, one or more NPUs, one or more DSPs, etc., and/or any combination(s) thereof), and orchestration technology (e.g., application programming interface(s) (API(s)) that may assign computing task(s) to whichever one(s) of the multiple types of programmable circuitry is/are suited and available to perform the computing task(s).

As used herein integrated circuit/circuitry is defined as one or more semiconductor packages containing one or more circuit elements such as transistors, capacitors, inductors, resistors, current paths, diodes, etc. For example an integrated circuit may be implemented as one or more of an ASIC, an FPGA, a chip, a microchip, programmable circuitry, a semiconductor substrate coupling multiple circuit elements, a system on chip (SoC), etc.

From the foregoing, it will be appreciated that example systems, apparatus, articles of manufacture, and methods have been disclosed that control (e.g., adjust, increase, etc.) steering assistance to enable vehicular maneuvers to be made with a reduced rotation of the steering wheel. For example, the examples disclosed herein can adjust the steering assistance to enable a sharp turn (e.g., a 90° or greater turn) to be made with approximately a 90° degree rotation of the steering wheel. As such, examples disclosed herein can reduce driver discomfort associated with using a non-circular steering wheel.

Example methods, apparatus, systems, and articles of manufacture to control steering assistance are disclosed herein. Further examples and combinations thereof include the following:

Example 1 includes a vehicle comprising a steering wheel, a steerable wheel operatively coupled to the steering wheel, and programmable circuitry to identify a first angular displacement of the steering wheel, cause the steerable wheel to have a second angular displacement corresponding to the first angular displacement of the steering wheel at a first time, and cause the steerable wheel to have a third angular displacement corresponding to the first angular displacement of the steering wheel at a second time different from the first time, the third angular displacement different from the second angular displacement.

Example 2 includes the vehicle of example 1, wherein the programmable circuitry is to determine a first maneuver to be performed at the first time, and determine a second maneuver to be performed at the second time, the second maneuver different from the first maneuver.

Example 3 includes the vehicle of example 2, wherein the vehicle includes an external environment sensor, and wherein the programmable circuitry is to determine the first maneuver and the second maneuver based on an output of the external environment sensor.

Example 4 includes the vehicle of example 2, wherein the programmable circuitry is to determine the first maneuver and the second maneuver based on a destination for the vehicle.

Example 5 includes the vehicle of example 1, wherein the steering wheel has the first angular displacement as a result of a user turning the steering wheel.

Example 6 includes the vehicle of example 1, wherein the programmable circuitry is to cause the first angular displacement of the steering wheel to correspond to the second angular displacement of the steerable wheel when the vehicle is to travel along a first trajectory, and cause the first angular displacement of the steering wheel to correspond to the third angular displacement of the steerable wheel when the vehicle is to travel along a second trajectory different from the first trajectory.

Example 7 includes the vehicle of example 1, wherein the programmable circuitry is to cause the first angular displacement of the steering wheel to correspond to the second angular displacement of the steerable wheel when the vehicle is traveling at a first speed, and cause the first angular displacement of the steering wheel to correspond to the third angular displacement of the steerable wheel when the vehicle is traveling at a second speed different from the first speed.

Example 8 includes the vehicle of example 1, wherein, to cause the steerable wheel to have the second angular displacement or the third angular displacement, the programmable circuitry adjusts a gain of an electrical signal transmitted to a steering actuator that turns the steerable wheel.

Example 9 includes the vehicle of example 1, wherein, to cause the steerable wheel to have the second angular displacement or the third angular displacement, the programmable circuitry causes an adjustment to an engagement between gears.

Example 10 includes the vehicle of example 9, wherein gears include a first gear and a second gear, and wherein the adjustment causes the first gear to move and engage with a different portion of the second gear than before the adjustment.

Example 11 includes the vehicle of example 10, wherein the first gear includes a conical shape.

Example 12 includes an apparatus comprising interface circuitry, machine readable instructions, and programmable circuitry to at least one of instantiate or execute the machine readable instructions to cause an adjustment to a relationship between a steering wheel angle change and an orientational change of steerable wheels based on a maneuver to be performed by a vehicle.

Example 13 includes the apparatus of example 12, wherein the programmable circuitry is to identify the maneuver based on information from an optical sensor that detects optics external to the vehicle.

Example 14 includes the apparatus of example 12, wherein, to cause the adjustment to the relationship, the programmable circuitry is to cause a first output signal to be delivered to a steering actuator when the steering wheel angle change is a first steering wheel angle change and the maneuver is a first maneuver, and cause a second output signal to be delivered to a steering actuator when the steering wheel angle change is a second steering wheel angle change and the maneuver is a second maneuver different from the first maneuver, the second output signal different than the first output signal.

Example 15 includes the apparatus of example 12, wherein, to cause the adjustment to the relationship, the programmable circuitry is to adjust a gear ratio in a steering actuator of the vehicle.

Example 16 includes the apparatus of example 12, wherein the programmable circuitry is to limit the adjustment to the relationship based on a speed of the vehicle.

Example 17 includes the apparatus of example 12, wherein the programmable circuitry is to increase a steering ratio associated with the relationship when the maneuver includes turning the vehicle at an intersection.

Example 18 includes a method comprising identifying a first angular displacement of a steering wheel of a vehicle, causing a steerable wheel to have a second angular displacement corresponding to the first angular displacement of the steering wheel at a first time, and causing the steerable wheel to have a third angular displacement corresponding to the first angular displacement of the steering wheel at a second time different from the first time, the third angular displacement different from the second angular displacement.

Example 19 includes the method of example 18, further including determining a first maneuver to be performed at the first time, and determining a second maneuver to be performed at the second time, the second maneuver different from the first maneuver.

Example 20 includes the method of example 18, causing the first angular displacement of the steering wheel to correspond to the second angular displacement of the steerable wheel when the vehicle is to travel along a first trajectory, and causing the first angular displacement of the steering wheel to correspond to the third angular displacement of the steerable wheel when the vehicle is to travel along a second trajectory different from the first trajectory.

The following claims are hereby incorporated into this Detailed Description by this reference. Although certain example systems, apparatus, articles of manufacture, and methods have been disclosed herein, the scope of coverage of this patent is not limited thereto. On the contrary, this patent covers all systems, apparatus, articles of manufacture, and methods fairly falling within the scope of the claims of this patent.

What is claimed is:

1. A vehicle comprising:
a steering wheel;
a steerable wheel operatively coupled to the steering wheel; and
programmable circuitry to:
identify a first angular displacement of the steering wheel;
cause the steerable wheel to have a second angular displacement corresponding to the first angular displacement of the steering wheel at a first time; and
cause the steerable wheel to have a third angular displacement corresponding to the first angular displacement of the steering wheel at a second time different from the first time, the third angular displacement different from the second angular displacement.

2. The vehicle of claim 1, wherein the programmable circuitry is to:
determine a first maneuver to be performed at the first time; and
determine a second maneuver to be performed at the second time, the second maneuver different from the first maneuver.

3. The vehicle of claim 2, wherein the vehicle includes an external environment sensor, and wherein the programmable circuitry is to determine the first maneuver and the second maneuver based on an output of the external environment sensor.

4. The vehicle of claim 2, wherein the programmable circuitry is to determine the first maneuver and the second maneuver based on a destination for the vehicle.

5. The vehicle of claim 1, wherein the steering wheel has the first angular displacement as a result of a user turning the steering wheel.

6. The vehicle of claim 1, wherein the programmable circuitry is to:
cause the first angular displacement of the steering wheel to correspond to the second angular displacement of the steerable wheel when the vehicle is to travel along a first trajectory; and
cause the first angular displacement of the steering wheel to correspond to the third angular displacement of the steerable wheel when the vehicle is to travel along a second trajectory different from the first trajectory.

7. The vehicle of claim 1, wherein the programmable circuitry is to:
cause the first angular displacement of the steering wheel to correspond to the second angular displacement of the steerable wheel when the vehicle is traveling at a first speed; and
cause the first angular displacement of the steering wheel to correspond to the third angular displacement of the steerable wheel when the vehicle is traveling at a second speed different from the first speed.

8. The vehicle of claim 1, wherein, to cause the steerable wheel to have the second angular displacement or the third angular displacement, the programmable circuitry adjusts a gain of an electrical signal transmitted to a steering actuator that turns the steerable wheel.

9. The vehicle of claim 1, wherein, to cause the steerable wheel to have the second angular displacement or the third angular displacement, the programmable circuitry causes an adjustment to an engagement between gears.

10. The vehicle of claim 9, wherein gears include a first gear and a second gear, and wherein the adjustment causes the first gear to move and engage with a different portion of the second gear than before the adjustment.

11. The vehicle of claim 10, wherein the first gear includes a conical shape.

12. An apparatus comprising:
interface circuitry;
machine readable instructions; and
programmable circuitry to at least one of instantiate or execute the machine readable instructions to cause an adjustment to a relationship between a steering wheel angle change and an orientational change of steerable wheels based on a maneuver to be performed by a vehicle.

13. The apparatus of claim 12, wherein the programmable circuitry is to identify the maneuver based on information from an optical sensor that detects optics external to the vehicle.

14. The apparatus of claim 12, wherein, to cause the adjustment to the relationship, the programmable circuitry is to:
cause a first output signal to be delivered to a steering actuator when the steering wheel angle change is a first steering wheel angle change and the maneuver is a first maneuver; and
cause a second output signal to be delivered to a steering actuator when the steering wheel angle change is a second steering wheel angle change and the maneuver is a second maneuver different from the first maneuver, the second output signal different than the first output signal.

15. The apparatus of claim 12, wherein, to cause the adjustment to the relationship, the programmable circuitry is to adjust a gear ratio in a steering actuator of the vehicle.

16. The apparatus of claim 12, wherein the programmable circuitry is to limit the adjustment to the relationship based on a speed of the vehicle.

17. The apparatus of claim 12, wherein the programmable circuitry is to increase a steering ratio associated with the relationship when the maneuver includes turning the vehicle at an intersection.

18. A method comprising:
identifying a first angular displacement of a steering wheel of a vehicle;
causing a steerable wheel to have a second angular displacement corresponding to the first angular displacement of the steering wheel at a first time; and
causing the steerable wheel to have a third angular displacement corresponding to the first angular displacement of the steering wheel at a second time different from the first time, the third angular displacement different from the second angular displacement.

19. The method of claim 18, further including:
determining a first maneuver to be performed at the first time; and
determining a second maneuver to be performed at the second time, the second maneuver different from the first maneuver.

20. The method of claim 18,
causing the first angular displacement of the steering wheel to correspond to the second angular displacement of the steerable wheel when the vehicle is to travel along a first trajectory; and
causing the first angular displacement of the steering wheel to correspond to the third angular displacement of the steerable wheel when the vehicle is to travel along a second trajectory different from the first trajectory.
